(19) United States
(12) Patent Application Publication
(10) Pub. No.: US 2026/0124642 A1
(43) Pub. Date: May 7, 2026

(54) SYSTEMS AND METHODS FOR TREATING A SUBSTRATE

(71) Applicant: PPG Industries Ohio, Inc., Cleveland, OH (US)

(72) Inventors: Rachel D. Harris, Munster, IN (US); Kristi M. Allen, Pittsburgh, PA (US); Elizabeth S. Brown-Tseng, Gibsonia, PA (US); Justin J. Martin, Harrison City, PA (US); Kuldeep Kumar, Freemont, CA (US); Mark W. McMillen, Cabot, PA (US); Silvia Bezer, Suwanee, GA (US)

(73) Assignee: PPG Industries Ohio, Inc., Cleveland, OH (US)

(21) Appl. No.: 19/218,991

(22) Filed: May 27, 2025

Related U.S. Application Data
(62) Division of application No. 17/754,483, now abandoned.
(60) Provisional application No. 62/913,482, filed on Oct. 10, 2019.

(51) Int. Cl. B05D 3/10; B05D 7/00; B05D 7/14

(52) U.S. Cl. CPC B05D 3/102; B05D 7/14; B05D 7/54; B05D 2202/20; B05D 2350/00; B05D 2518/10

(57) ABSTRACT

Disclosed herein are systems and methods for treating a metal substrate. The system includes a first pretreatment composition comprising a fluorometallic acid and free fluoride and having a pH of 1.0 to 4.0 and a second pretreatment composition comprising a Group IVB metal or a third pretreatment comprising a lanthanide series metal and an oxidizing agent. The method includes contacting at least a portion of a surface of the substrate with the first pretreatment composition and optionally contacting at least a portion of the substrate surface with the second pretreatment composition or the third pretreatment composition. Also disclosed are substrates treated with one of the systems or methods. Also disclosed are magnesium or magnesium alloy substrates comprising a bilayer comprising a first layer comprising silicon and a second layer comprising fluoride.

### CROSS-REFERENCE TO RELATED APPLICATIONS

This application is a divisional application of U.S. patent application Ser. No. 17/754,483, filed on Apr. 4, 2022, which is a national phase entry of International Application No. PCT/US2020/045629, filed on Aug. 10, 2020, that claimed the benefit of U.S. Provisional Application No. 62/913,482, filed on Oct. 10, 2019, each of which are incorporated herein by reference.

### GOVERNMENT CONTRACT

This material is based upon work supported by the U.S. Department of Energy, Office of Energy Efficiency and Renewable Energy under Cooperative Agreement DE-EE007756 entitled U.S. Automotive Materials Partnership Low-Cost Mg Sheet Component Development and Demonstration Project.

### FIELD OF THE INVENTION

The present invention relates to compositions, systems, and methods for treating a substrate.

### BACKGROUND OF THE INVENTION

The use of protective coatings on metal substrates for improved corrosion resistance and paint adhesion is common. Conventional techniques for coating such substrates include techniques that involve pretreating the metal substrate with chromium-containing compositions. The use of such chromate-containing compositions, however, imparts environmental and health concerns.

### SUMMARY OF THE INVENTION

Disclosed herein is a method of treating a metal substrate comprising: contacting at least a portion of a surface of the substrate with a first pretreatment composition comprising a fluorometallic acid comprising a Group IVA metal and/or a Group IVB metal and free fluoride in an amount of 10 ppm to 500 ppm based on total weight of the first pretreatment composition and having a pH of 1.0 to 4.0 and contacting at least a portion of the substrate surface with a second pretreatment composition comprising a Group IVB metal and free fluoride in an amount of 15 ppm to 200 ppm based on total weight of the second pretreatment composition or a third pretreatment comprising a lanthanide series metal and an oxidizing agent.

Also disclosed herein is a substrate comprising a surface, wherein at least a portion of the surface is treated with one of the systems or methods of the present invention.

### BRIEF DESCRIPTION OF THE FIGURES

FIG. 1A shows top/down SEM imaging of a panel pretreated with Pretreatment D in Example 1: FIG. 1B shows a panel pretreated with Pretreatment D in Example 2.

FIG. 2A shows an XPS depth profile of a panel treated with Pretreatment D in Example 1: FIG. 2B shows a panel pretreated with Pretreatment D in Example 2.

FIG. 3 shows an XPS depth profile of a panel immersed in Pretreatment-I (PT-1) in Example 2 and demonstrates the change in atomic percent of (A) magnesium, (B) oxygen, (C) fluoride, and (D) silicon on ZEK100 magnesium alloy as a function of immersion time.

FIGS. 4A-F show FIB-EDS-TEM of a ZEK100 magnesium substrate treated according to Example 2 (PT-1, followed by PT-D). FIG. 4A shows a high-angle annular diffraction TEM micrograph. FIGS. 4B-4F are TEM micrographs overlaid with elemental maps (4B, zirconium; 4C, magnesium; 4D, fluoride; 4E, silicon; 4F, oxygen) as determined by EDS.

FIGS. 5A-E show FIB-EDS-TEM Sof an Eform Plus magnesium substrate treated according to Example 12 (PT-1 with no second pretreatment). FIG. 5A shows a high-angle annular diffraction TEM micrograph. FIGS. 5B-4E show are TEM micrographs overlaid with elemental maps (5B, magnesium; 5C, fluoride; 5D, silicon; 5E, oxygen) as determined by EDS.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to” “a” Group IV metal and “an” oxidizing agent, a combination (i.e., a plurality) of these components can be used.

In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

As used herein, the terms “on,” “onto,” “applied on,” “applied onto,” “formed on,” “deposited on,” “deposited onto,” mean formed, overlaid, deposited, or provided on but not necessarily in contact with the surface. For example, a coating composition “applied onto” a substrate does not preclude the presence of one or more other intervening coating layers of the same or different composition located between the coating composition and the substrate.

As used herein, a “system” refers to a plurality of treatment compositions (including cleaners and rinses) used to treat a substrate and to produce a treated substrate. The system may be part of a production line (such as a factory production line) that produces a finished substrate or a treated substrate that is suitable for use in other production lines. As used herein, reference to a “first pretreatment composition,” a “second pretreatment composition”, and a “third pretreatment composition” is not intended to imply any specific order of treatment but rather is for ease of reference only.

As used herein, a “salt” refers to an ionic compound made up of metal cations and non-metallic anions and having an overall electrical charge of zero. Salts may be hydrated or anhydrous.

As used herein, “aqueous composition” refers to a solution or dispersion in a medium that comprises predominantly water. For example, the aqueous medium may comprise water in an amount of more than 50 wt. %, or more than 70 wt. % or more than 80 wt. % or more than 90 wt. % or more than 95 wt. % based on the total weight of the medium. That is, the aqueous medium may for example consist substantially of water.

As used herein, the term “dispersion” refers to a two-phase transparent, translucent or opaque system in which metal phosphate particles are in the dispersed phase and an aqueous medium, which includes water, is in the continuous phase.

As used herein, “pretreatment composition” refers to a composition that is capable of reacting with and chemically altering the substrate surface and binding to it to form a film that affords corrosion protection.

As used herein, “pretreatment bath” refers to an aqueous bath containing the pretreatment composition and that may contain components that are byproducts of the process.

As used herein, the terms “Group IA metal” and “Group IA element” refer to an element that is in Group IA of the CAS version of the Periodic Table of the Elements as is shown, for example, in the Handbook of Chemistry and Physics, 63^{rd} edition (1983), corresponding to Group 1 in the actual IUPAC numbering.

As used herein, the term “Group IA metal compound” refers to compounds that include at least one element that is in Group IA of the CAS version of the Periodic Table of the Elements.

As used herein, the terms “Group IVA metal” and “Group IVA element” refer to an element that is in group IVA of the CAS version of the Periodic Table of the Elements as is shown, for example, in the Handbook of Chemistry and Physics, 63^{rd} edition (1983), corresponding to Group 14 in the actual IUPAC numbering.

As used herein, the terms “Group IVA metal compound” refer to compounds that include at least one element that is in Group IVA of the CAS version of the Periodic Table of the Elements.

As used herein, the terms “Group IVB metal” and “Group IVB element” refer to an element that is in group IVB of the CAS version of the Periodic Table of the Elements as is shown, for example, in the Handbook of Chemistry and Physics, 63^{rd} edition (1983), corresponding to Group 4 in the actual IUPAC numbering.

As used herein, the term “Group IVB metal compound” refers to compounds that include at least one element that is in Group IVB of the CAS version of the Periodic Table of the Elements.

As used herein, the terms “Group VIB metal” and “Group VIB element” refer to an element that is in group VIB of the CAS version of the Periodic Table of the Elements as is shown, for example, in the Handbook of Chemistry and Physics, 63^{rd} edition (1983), corresponding to Group 6 in the actual IUPAC numbering.

As used herein, the term “Group VIB metal compound” refers to compounds that include at least one element that is in Group VIB of the CAS version of the Periodic Table of the Elements.

As used herein, the terms “Group VIIIB metal” and “Group VIIIB element” refer to an element that is in group VIIIB of the CAS version of the Periodic Table of the Elements as is shown, for example, in the Handbook of Chemistry and Physics, 63^{rd} edition (1983), corresponding to Groups 8-10 in the actual IUPAC numbering.

As used herein, the term “Group VIIIB metal compound” refers to compounds that include at least one element that is in Group VIIIB of the CAS version of the Periodic Table of the Elements.

As used herein, the terms “Group IIB metal” and “Group IIB element” refer to an element that is in group XIIB of the CAS version of the Periodic Table of the Elements as is shown, for example, in the Handbook of Chemistry and Physics, 63^{rd} edition (1983), corresponding to Group 12 in the actual IUPAC numbering.

As used herein, the term “Group IIB metal compound” refers to compounds that include at least one element that is in Group IIB of the CAS version of the Periodic Table of the Elements.

As used herein, a “coating composition” refers to a composition, e.g., a solution, mixture, or a dispersion, that, in an at least partially dried or cured state, is capable of producing a film, layer, or the like on at least a portion of a substrate surface.

As further defined herein, ambient conditions generally refer to room temperature and humidity conditions or temperature and humidity conditions that are typically found in the area in which the coating composition is being applied to a substrate, e.g., at 10° C. to 40° C. and 5% to 80% relative humidity, while slightly thermal conditions are temperatures that are slightly above ambient temperature but are generally below the curing temperature for the coating composition (i.e. in other words, at temperatures and humidity conditions below which the reactive components will readily react and cure, e.g., >40° C. and less than 100° C. at 5% to 80% relative humidity).

As used herein, unless indicated otherwise, the term “substantially free” means that a particular material is not purposefully added to a mixture or composition, respectively, and is only present as an impurity in a trace amount of less than 2% by weight based on a total weight of the mixture or composition, respectively. As used herein, unless indicated otherwise, the term “essentially free” means that a particular material is only present in an amount of less than 0.5% by weight based on a total weight of the mixture or composition, respectively. As used herein, unless indicated otherwise, the term “completely free” means that a mixture or composition, respectively, does not comprise a particular material, i.e., the mixture or composition comprises 0% by weight of such material, or that such material is below the detection limit of common analytical techniques.

Unless otherwise disclosed herein, as used herein, the terms “total composition weight”, “total weight of a composition” or similar terms refer to the total weight of all ingredients being present in the respective composition including any carriers and solvents.

As mentioned above, the present invention is directed to a system for treating a metal substrate, the system comprising, or consisting essentially of, or consisting of, (a) a first pretreatment composition, and (b) a second pretreatment composition or (c) a third pretreatment composition. The first pretreatment composition may comprise, or consist essentially of, or consist of, a fluorometallic acid comprising a Group IVA metal and/or a Group IVB metal and free fluoride in an amount of 10 ppm to 500 ppm based on total weight of the first pretreatment composition and may have a pH of 1.0 to 4.0. The second pretreatment composition may comprise, or consist essentially of, or consist of, a Group IVB metal and free fluoride in an amount of 15 ppm to 200 ppm based on total weight of the second pretreatment composition. The third pretreatment composition may comprise, or consist essentially of, or consist of, a rare earth metal and an oxidizing agent.

The present invention also is directed to a method of treating a metal substrate. The method may comprise, or may consist essentially of, or may consist of, contacting at least a portion of the substrate surface with one of the first compositions described herein. Optionally, the method may further comprise, or may consist essentially of, or may consist of, contacting at least a portion of the substrate surface with one of the second compositions described herein and/or one of the third compositions described herein. As described more fully herein, in some instances, there may be rinse steps that intervene the contacting with the first composition and the second composition or the third composition.

Suitable substrates that may be used include metal substrates, metal alloy substrates, and/or substrates that have been metallized, such as nickel-plated plastic. The metal or metal alloy can comprise or be steel, aluminum, zinc, nickel, and/or magnesium. For example, the steel substrate could be cold rolled steel, hot rolled steel, electrogalvanized steel, and/or hot dipped galvanized steel. Aluminum alloys of the 1XXX, 2XXX, 3XXX, 4XXX, 5XXX, 6XXX, or 7XXX series as well as clad aluminum alloys also may be used as the substrate. Aluminum alloys may comprise, for example, 0.01% by weight copper to 10% by weight copper. Aluminum alloys which are treated may also include castings, such as 1XX.X, 2XX.X, 3XX.X, 4XX.X, 5XX.X, 6XX.X, 7XX.X, 8XX.X, or 9XX.X (e.g.: A356.0). Magnesium alloys of the AZXX (including Eform Plus), AMXX, EVXX, ZKXX, ZEXX, ZCXX, HKXX, HZXX, QEXX, QHXX, WEXX, ZEK100, or Elektron 21 series also may be used as the substrate. The substrate used may also comprise titanium and/or titanium alloys, zinc and/or zinc alloys, and/or nickel and/or nickel alloys. Suitable substrates for use in the present invention include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, personal electronics, agricultural equipment, lawn and garden equipment, air conditioning units, heat pump units, heat exchangers, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part.

In examples, the substrate may be a multi-metal article. As used herein, the term “multi-metal article” refers to (1) an article that has at least one surface comprised of a first metal and at least one surface comprised of a second metal that is different from the first metal, (2) a first article that has at least one surface comprised of a first metal and a second article that has at least one surface comprised of a second metal that is different from the first metal, or (3) both (1) and (2).

In examples, the substrate may comprise a three-dimensional component formed by an additive manufacturing process such as selective laser melting, e-beam melting, directed energy deposition, binder jetting, metal extrusion, and the like. In examples, the three-dimensional component may be a metal and/or resinous component.

### First Pretreatment Composition

As stated above, the first pretreatment composition comprises a fluorometallic acid and free fluoride in an amount of 10 ppm to 500 ppm based on total weight of the first pretreatment composition. The metal of the fluorometallic acid may comprise, for example, a Group IVA metal and/or a Group IVB metal.

The Group IVA metal may, for example, comprise silicon such as silanes, silicas, silicates, and the like. The Group IVA metal may be provided in the first pretreatment composition in the form of specific compounds of the metals, such as their soluble acids and/or salts. Examples of useful compounds include fluorosilicic acid, ammonium and alkali metal fluorosilicates, and the like, including by way of non-limiting example, hexafluorosilicic acid, hexafluorozirconic acid, hexafluorotitanic acid, hexafluoroferric acid, hexafluoroaluminic acid, or combinations thereof.

The Group IVA metal, if present at all, may be present in the first pretreatment composition in an amount of at least 10 ppm based on total weight of the first pretreatment composition, such as at least 50 ppm, such as at least 100 ppm, and may be present in the first pretreatment composition in an amount of no more than 1,500 ppm based on total weight of the first pretreatment composition, such as no more than 750 ppm, such as no more than 250 ppm. The Group IVA metal, if present at all, may be present in the first pretreatment composition in an amount of 10 ppm to 1,500 ppm based on total weight of the first pretreatment composition, such as 50 ppm to 750 ppm, such as 100 ppm to 250 ppm.

The Group IVB metal may comprise zirconium, titanium, hafnium, or combinations thereof. For example, the Group IVB metal used in the first pretreatment composition may be a compound of zirconium, titanium, hafnium, or a mixture thereof. Suitable compounds of zirconium include, but are not limited to, hexafluorozirconic acid, alkali metal and ammonium salts thereof, zirconium tetrafluoride, ammonium zirconium carbonate, zirconium carboxylates and zirconium hydroxy carboxylates, such as zirconium acetate, zirconium oxalate, ammonium zirconium glycolate, ammonium zirconium lactate, ammonium zirconium citrate, zirconium basic carbonate, and mixtures thereof. Suitable compounds of titanium include, but are not limited to, fluorotitanic acid and its salts. A suitable compound of hafnium includes, but is not limited to, hafnium nitrate.

The Group IVB metal, if present at all, may be present in the first pretreatment composition in an amount of at least 200 ppm based on total weight of the first pretreatment composition, such as at least 350 ppm, such as at least 500 ppm. The Group IVB metal, if present at all, may be present in the first pretreatment composition in an amount of no more than 5,000 ppm based on total weight of the first pretreatment composition, such as no more than 2,500 ppm, such as no more than 1,750 ppm. The Group IVB metal may be present in the first pretreatment composition in a total amount of 200 ppm to 5,000 ppm based on total weight of the first pretreatment composition, such as 350 ppm to 2,500 ppm, such as 500 ppm to 1,750 ppm. In some instances, the composition may comprise more than one type of Group IVB metal. In such instances, each type of Group IVB metal may be present in the amounts disclosed above.

The first pretreatment composition may further comprise an anion that may be suitable for forming a salt with any of the Group IVA or Group IVB metals described above, such as a silicate (orthosilicates and metasilicates), carbonates, hydroxides, and the like.

A source of free fluoride may be present in the first pretreatment composition. The free fluoride may be derived from a compound or complex comprising the Group IVA metal and/or the Group IVB metal described above and/or may be derived from a compound or complex other than a compound or complex comprising the Group IVA metal and/or the Group IVB metal. As used herein the amount of fluoride disclosed or reported in the first pretreatment composition is referred to as “free fluoride,” that is, fluoride present in the first pretreatment composition that is not bound to metal ions or hydrogen ions, as measured in parts per million of fluoride. Free fluoride is defined herein as being able to be measured using, for example, an Orion Dual Star Dual Channel Benchtop Meter equipped with a fluoride ion selective electrode (“ISE”) available from Thermoscientific, the symphony® Fluoride Ion Selective Combination Electrode supplied by VWR International, or similar electrodes. See, e.g., Light and Cappuccino, Determination offluoride in toothpaste using an ion-selective electrode, J. Chem. Educ., 52:4, 247-250, April 1975. The fluoride ISE may be standardized by immersing the electrode into solutions of known fluoride concentration and recording the reading in millivolts and then plotting these millivolt readings in a logarithmic graph. The millivolt reading of an unknown sample can then be compared to this calibration graph and the concentration of fluoride determined. Alternatively, the fluoride ISE can be used with a meter that will perform the calibration calculations internally and thus, after calibration, the concentration of the unknown sample can be read directly.

The free fluoride of the first pretreatment composition may be present in an amount of at least 10 ppm based on a total weight of the first pretreatment composition, such as at least 25 ppm, such as at least 35 ppm. The free fluoride of the first pretreatment composition may be present in an amount of no more than 500 ppm based on a total weight of the first pretreatment composition, such as no more than 200 ppm such as no more than 100 ppm, such as no more than 75 ppm. The free fluoride of the first pretreatment composition may be present in an amount of 10 ppm free fluoride to 500 ppm free fluoride based on a total weight of the first pretreatment composition, such as 10 ppm to 200 ppm, such as 25 ppm to 100 ppm, 35 ppm to 75 ppm.

The first pretreatment composition may exclude chromium or chromium-containing compounds. As used herein, the term “chromium-containing compound” refers to materials that include trivalent and/or hexavalent chromium. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, strontium dichromate, chromium(III) sulfate, chromium(III) chloride, and chromium(III) nitrate. When a first pretreatment composition or a material deposited on a substrate surface by deposition of the first pretreatment composition is substantially free, essentially free, or completely free of chromium, this includes chromium in any form, such as, but not limited to, the trivalent and hexavalent chromium-containing compounds listed above.

Thus, optionally, the first pretreatment compositions and/or material deposited on a substrate surface by deposition of the first pretreatment composition may be substantially free, may be essentially free, and/or may be completely free of one or more of any of the elements or compounds listed in the preceding paragraph. A first pretreatment composition or a material deposited on a substrate surface by deposition of the first pretreatment composition that is substantially free of chromium or derivatives thereof means that chromium or derivatives thereof are not intentionally added, but may be present in trace amounts, such as because of impurities or unavoidable contamination from the environment. In other words, the amount of material is so small that it does not affect the properties of the first pretreatment composition or deposited material; in the case of chromium, this may further include that the element or compounds thereof are not present in the first pretreatment compositions and/or deposited material in such a level that it causes a burden on the environment. The term “substantially free” means that the first pretreatment compositions and/or deposited material contain less than 10 ppm of any or all of the elements or compounds listed in the preceding paragraph based on total weight of the composition or the layer, respectively, if any at all. The term “essentially free” means that the first pretreatment compositions and/or deposited material contain less than 1 ppm of any or all of the elements or compounds listed in the preceding paragraph, if any at all. The term “completely free” means that the first pretreatment compositions and/or deposited material contain less than 1 ppb of any or all of the elements or compounds listed in the preceding paragraph, if any at all.

The first pretreatment composition may, in some instances, exclude phosphate ions or phosphate-containing compounds and/or the formation of sludge, such as aluminum phosphate, iron phosphate, and/or zinc phosphate, formed in the case of using a treating agent based on zinc phosphate. As used herein, “phosphate-containing compounds” include compounds containing the element phosphorous such as ortho phosphate, pyrophosphate, metaphosphate, tripolyphosphate, organophosphonates, and the like, and can include, but are not limited to, monovalent, divalent, or trivalent cations such as: sodium, potassium, calcium, zinc, nickel, manganese, aluminum and/or iron. When a composition and/or a material deposited on a substrate surface by deposition of the first pretreatment composition is substantially free, essentially free, or completely free of phosphate, this includes phosphate ions or compounds containing phosphate in any form.

Thus, the first pretreatment composition and/or a material deposited on a substrate surface by deposition of the first pretreatment composition may be substantially free, or in some cases may be essentially free, or in some cases may be completely free, of one or more of any of the ions or compounds listed in the preceding paragraph. A first pretreatment composition and/or deposited material is substantially free of phosphate means that phosphate ions or compounds containing phosphate are not intentionally added, but may be present in trace amounts, such as because of impurities or unavoidable contamination from the environment. In other words, the amount of material is so small that it does not affect the properties of the composition; this may further include that phosphate is not present in the first pretreatment compositions and/or deposited materials in such a level that they cause a burden on the environment. The term “substantially free” means that the first pretreatment compositions and/or deposited material contain less than 5 ppm of any or all of the phosphate anions or compounds listed in the preceding paragraph based on total weight of the composition or the deposited material, respectively, if any at all. The term “essentially free” means that the first pretreatment compositions and/or deposited material less than 1 ppm of any or all of the phosphate anions or compounds listed in the preceding paragraph. The term “completely free” means that the first pretreatment compositions and/or deposited material contain less than 1 ppb of any or all of the phosphate anions or compounds listed in the preceding paragraph, if any at all.

The pH of the first pretreatment composition may be at least 1.0, such as at least 2.0, such as at least 2.2, and in some instances may be 4.0 or less, such as 3.5 or less, such as 2.5 or less, such as 2.7 or less. The pH of the first pretreatment composition may, in some instances, be 1.0 to 4.0, such as 1.0 to 3.5, such as 2.0 to 3.0, such as 2.2 to 2.7, and may be adjusted using, for example, any acid and/or base as is necessary. The pH of the first pretreatment composition may be maintained through the inclusion of an acidic material, including water soluble and/or water dispersible acids, such as nitric acid, sulfuric acid, and/or phosphoric acid. The pH of the first pretreatment composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

The first pretreatment composition may comprise an aqueous medium and may optionally contain other materials such as nonionic surfactants and auxiliaries conventionally used in the art of treatment compositions. Other optional materials include surfactants that function as defoamers or substrate wetting agents. Anionic, cationic, amphoteric, and/or nonionic surfactants may be used. Defoaming surfactants may optionally be present at levels up to 1 weight percent, such as up to 0.1 percent by weight, and wetting agents are typically present at levels up to 2 percent, such as up to 0.5 percent by weight based on the total weight of the first pretreatment composition.

The first pretreatment composition may comprise a carrier, often an aqueous medium, so that the composition is in the form of a solution or dispersion of the Group IVA and/or Group IVB metals in the carrier. For example, the first pretreatment composition may be an aqueous composition. The solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion when applied to the metal substrate is at a temperature ranging from 40° F. to 185° F., such as 60° F. to 110° F., such as 70° F. to 90° F. For example, the first pretreatment process may be carried out at ambient or room temperature. The contact time is often from 5 seconds to 15 minutes, such as 10 seconds to 10 minutes, such as 15 seconds to 3 minutes.

Following the contacting with a first pretreatment composition disclosed herein, the substrate optionally may be air dried at room temperature or may be dried with hot air, for example, by using an air knife, by flashing off the water by brief exposure of the substrate to a high temperature, such as by drying the substrate in an oven at 15° C. to 200° C. or in a heater assembly using, for example, infrared heat, such as for 10 minutes at 70° C., or by passing the substrate between squeegee rolls. Following the contacting with a first pretreatment composition, the substrate optionally may be rinsed with tap water, deionized water, and/or an aqueous solution of rinsing agents in order to remove any residue and then optionally may be dried, for example air dried or dried with hot air as described in the preceding sentence, such as by drying the substrate in an oven at 15° C. to 100° C., such as 20° C. to 90° C., or in a heater assembly using, for example, infrared heat, such as for 10 minutes at 70° C., or by passing the substrate between squeegee rolls. Following the contacting with a first pretreatment composition, and any optional rinsing stages, a second pretreatment composition or a third pretreatment composition (described below) may be deposited onto at least a portion of the surface of the pretreated substrate by any suitable technique, including, for example, brushing, dipping, flow coating, spraying and the like.

### Second Pretreatment Compositions

As stated above, the second pretreatment composition comprises a Group IVB metal and free fluoride in an amount of 15 ppm to 200 ppm based on total weight of the second pretreatment composition.

The Group IVB metal may comprise zirconium, titanium, hafnium, or combinations thereof and may be any of the compounds described above with respect to the first pretreatment compositions.

The Group IVB metal may be present in the second pretreatment composition in a total amount of at least 20 ppm metal based on total weight of the second pretreatment composition, such as at least 50 ppm metal, or, in some cases, at least 70 ppm metal. The Group IVB metal may be present in the second pretreatment composition in a total amount of no more than 1,000 ppm metal based on total weight of the second pretreatment composition, such as no more than 600 ppm metal, or, in some cases, no more than 300 ppm metal. The Group IVB metal may be present in the second pretreatment composition in a total amount of 20 ppm metal to 1,000 ppm metal based on total weight of the second pretreatment composition, such as from 50 ppm metal to 600 ppm metal, such as from 70 ppm metal to 300 ppm metal. As used herein, the term “total amount,” when used with respect to the amount of Group IVB metal, means the sum of all Group IV metals present in the second pretreatment composition.

The second pretreatment composition also may comprise a Group IA metal such as lithium. The source of Group IA metal in the second pretreatment composition may be in the form of a salt. Non-limiting examples of suitable lithium salts include lithium nitrate, lithium sulfate, lithium fluoride, lithium chloride, lithium hydroxide, lithium carbonate, lithium iodide, and combinations thereof.

The Group I metal may be present in the second pretreatment composition in an amount of at least 2 ppm based on a total weight of the second pretreatment composition, such as at least 5 ppm, such as at least 25 ppm, such as at least 75 ppm, and in some instances, may be present in amount of no more than 500 ppm based on a total weight of the pretreatment composition, such as no more than 250 ppm, such as no more than 125 ppm, such as no more than 100 ppm. The Group IA metal may be present in the second pretreatment composition in an amount of 2 ppm to 500 ppm based on a total weight of the pretreatment composition, such as 5 ppm to 250 ppm, such as 5 ppm to 125 ppm, such as 5 ppm to 25 ppm.

The second pretreatment composition may also comprise a Group VIB metal. The source of Group VIB metal in the second pretreatment composition may be in the form of a salt. Non-limiting examples of suitable molybdenum salts include sodium molybdate, lithium molybdate, calcium molybdate, potassium molybdate, ammonium molybdate, molybdenum chloride, molybdenum acetate, molybdenum sulfamate, molybdenum formate, molybdenum lactate, and combinations thereof.

The Group VIB metal may be present in the second pretreatment composition in an amount of at least 5 ppm based on a total weight of the second pretreatment composition, such as at least 25 ppm, such as 100 ppm, and in some instances, may be present in the second composition in an amount of no more than 500 ppm based on total weight of the second pretreatment composition, such as no more than 250 ppm, such as no more than 150 ppm. The Group VIB metal may be present in the second pretreatment composition in an amount of 5 ppm to 500 ppm based on total weight of the pretreatment composition, such as 25 ppm to 250 ppm, such as 40 ppm to 120 ppm.

The second pretreatment composition may further comprise an anion that may be suitable for forming a salt with the pretreatment composition metal cations, such as a halogen, a nitrate, a sulfate, a silicate (orthosilicates and metasilicates), carbonates, hydroxides, and the like.

The second pretreatment composition also may comprise an electropositive metal ion. As used herein, the term “electropositive metal ion” refers to metal ions that will be reduced by the metal substrate being treated when the pretreatment solution contacts the surface of the metallic substrate. As will be appreciated by one skilled in the art, the tendency of chemical species to be reduced is called the reduction potential, is expressed in volts, and is measured relative to the standard hydrogen electrode, which is arbitrarily assigned a reduction potential of zero. The reduction potential for several elements is set forth in Table 1 below (according to the CRC 82^{nd} Edition, 2001-2002). An element or ion is more easily reduced than another element or ion if it has a voltage value, E*, in the following table, that is more positive than the elements or ions to which it is being compared.

TABLE 1

| Element | Reduction half-cell reaction | Voltage, E* |
|---|---|---|
| Potassium | K⁺ + e → K | −2.93 |
| Calcium | Ca²⁺ + 2e → Ca | −2.87 |
| Sodium | Na⁺ + e → Na | −2.71 |
| Magnesium | Mg²⁺ + 2e → Mg | −2.37 |
| Aluminum | Al³⁺ + 3e → Al | −1.66 |
| Zinc | Zn²⁺ + 2e → Zn | −0.76 |
| Iron | Fe²⁺ + 2e → Fe | −0.45 |
| Nickel | Ni²⁺ + 2e → Ni | −0.26 |
| Tin | Sn²⁺ + 2e → Sn | −0.14 |
| Lead | Pb²⁺ + 2e → Pb | −0.13 |
| Hydrogen | 2H⁺ + 2e → H₂ | −0.00 |
| Copper | Cu²⁺ + 2e → Cu | 0.34 |
| Mercury | Hg₂²⁺ + 2e → 2Hg | 0.80 |
| Silver | Ag⁺ + e → Ag | 0.80 |
| Gold | Au³⁺ + 3e → Au | 1.50 |

Thus, as will be apparent, when the metal substrate comprises one of the materials listed earlier, such as cold rolled steel, hot rolled steel, steel coated with zinc metal, zinc compounds, or zinc alloys, hot-dipped galvanized steel, galvanealed steel, steel plated with zinc alloy, aluminum alloys, aluminum plated steel, aluminum alloy plated steel, magnesium and magnesium alloys, suitable electropositive metal ions for deposition thereon include, for example, nickel, copper, silver, and gold, as well mixtures thereof.

When the electropositive metal ion comprises copper, both soluble and insoluble compounds may serve as a source of copper ions in the second pretreatment compositions. For example, the supplying source of copper ions in the pretreatment composition may be a water-soluble copper compound. Specific examples of such compounds include, but are not limited to, copper sulfate, copper nitrate, copper thiocyanate, disodium copper ethylenediaminetetraacetate tetrahydrate, copper bromide, copper oxide, copper hydroxide, copper chloride, copper fluoride, copper gluconate, copper citrate, copper lauroyl sarcosinate, copper lactate, copper oxalate, copper tartrate, copper malate, copper succinate, copper malonate, copper maleate, copper benzoate, copper salicylate, copper amino acid complexes, copper fumarate, copper glycerophosphate, sodium copper chlorophyllin, copper fluorosilicate, copper fluoroborate and copper iodate, as well as copper salts of carboxylic acids such as in the homologous series formic acid to decanoic acid, and copper salts of polybasic acids in the series oxalic acid to suberic acid.

When copper ions supplied from such a water-soluble copper compound are precipitated as an impurity in the form of copper sulfate, copper oxide, etc., it may be desirable to add a complexing agent that suppresses the precipitation of copper ions, thus stabilizing them as a copper complex in the composition.

The copper compound may be added as a copper complex salt such as or Cu-EDTA, which can be present stably in the second pretreatment composition on its own, but it is also possible to form a copper complex that can be present stably in the pretreatment composition by combining a complexing agent with a compound that is difficult to solubilize on its own. A n example thereof includes a Cu-EDTA complex formed by a combination of CuSO₄ and EDTA•2Na.

The electropositive metal ion may be present in the second pretreatment composition in an amount of at least 2 ppm based on the total weight of the pretreatment composition, such as at least 4 ppm, such as at least 6 ppm, such as at least 8 ppm, such as at least 10 ppm. The electropositive metal ion may be present in the second pretreatment composition in an amount of no more than 100 ppm based on the total weight of the second pretreatment composition, such as no more than 80 ppm, such as no more than 60 ppm, such as no more than 40 ppm, such as no more than 20 ppm. The electropositive metal ion may be present in the second pretreatment composition in an amount of from 2 ppm to 100 ppm (calculated as metal ion), based on the total weight of the second pretreatment composition, such as from 4 ppm to 80 ppm, such as from 6 ppm to 60 ppm, such as from 8 ppm to 40 ppm.

A source of free fluoride (as defined above) may be present in the second pretreatment composition. Free fluoride in the second pretreatment composition may be derived from Group IVB metals present in the second pretreatment composition, including, for example, hexafluorozirconic acid or hexafluorotitanic acid. Additionally, other complex fluorides, such as H₂SiF₆ or HBF₄, can be added to the second pretreatment composition to supply free fluoride. The skilled artisan will understand that the presence of free fluoride in the pretreatment bath can impact pretreatment deposition and etching of the substrate, hence it is critical to measure this bath parameter. The levels of free fluoride will depend on the pH and the addition of chelators into the second pretreatment bath and indicates the degree of fluoride association with the metal ions/protons present in the second pretreatment bath.

The free fluoride of the second pretreatment composition may be present in an amount of at least 15 ppm based on a total weight of the second pretreatment composition, such as at least 50 ppm. The free fluoride of the second pretreatment composition may be present in an amount of no more than 200 ppm based on a total weight of the second pretreatment composition, such as no more than 100 ppm. The free fluoride of the second pretreatment composition may be present in an amount of 15 ppm free fluoride to 200 ppm based on a total weight of the second pretreatment composition, such as 50 ppm fluoride to 100 ppm.

The second pretreatment composition optionally may comprise a Group VIIIB metal such as iron, cobalt, nickel, or combinations thereof. Suitable sources of Group VIIIB metals include iron (III) sulfate, iron (II) sulfate, iron (III) nitrate, iron (III) chloride, iron (III) oxide, iron (II) oxalate, cobalt (II) sulfate, cobalt (II) nitrate, cobalt (II) chloride, nickel (II) sulfate, nickel (II) nitrate, nickel (II) chloride, or combinations thereof.

The Group VIIIB metal, if present at all, may be present in the second pretreatment composition in an amount of at least 0.1 ppm based on total weight of the second pretreatment composition, such as at least 1 ppm, and may be present in an amount of no more than 50 ppm based on total weight of the second pretreatment composition, such as no more than 15 ppm. The Group VIIIB metal, if present at all, may be present in the second pretreatment composition in an amount of 0.1 ppm to 50 ppm based on total weight of the second pretreatment composition, such as 1 ppm to 15 ppm.

The second pretreatment composition may, in some instances, comprise an oxidizing agent. Non-limiting examples of the oxidizing agent include peroxides, persulfates, perchlorates, chlorates, hypochlorite, nitric acid, sparged oxygen, bromates, peroxi-benzoates, ozone, or combinations thereof.

The oxidizing agent may be present, if at all, in an amount of at least 50 ppm based on total weight of the second pretreatment composition, such as at least 500 ppm, and in some instances, may be present in an amount of no more than 13,000 ppm based on total weight of the second pretreatment composition, such as no more than 3,000 ppm. In some instances, the oxidizing agent may be present in the second pretreatment composition, if at all, in an amount of 100 ppm to 13,000 ppm based on total weight of the second pretreatment composition, such as 500 ppm to 3,000 ppm. As used herein, the term “oxidizing agent,” when used with respect to a component of the second pretreatment composition, refers to a chemical which is capable of oxidizing at least one of: a metal present in the substrate which is contacted by the second pretreatment composition and/or a metal-complexing agent present in the second pretreatment composition. As used herein with respect to “oxidizing agent,” the phrase “capable of oxidizing” means capable of removing electrons from an atom or a molecule present in the substrate or the second pretreatment composition, as the case may be, thereby decreasing the number of electrons of such atom or molecule.

As discussed above with respect to the first pretreatment composition, the second pretreatment composition may exclude chromium or chromium-containing compounds. That is, the second pretreatment composition and/or coatings or layers deposited from the second pretreatment composition may be substantially free, may be essentially free, and/or may be completely free of such chromium or chromium-containing compounds.

As discussed above with respect to the first pretreatment composition, the second pretreatment composition may, in some instances, exclude phosphate ions or phosphate-containing compounds and/or the formation of sludge. That is, the second pretreatment composition and/or coatings or layers deposited from the second pretreatment composition may be substantially free, or essentially free, or completely free, of phosphate ions or phosphate-containing compounds.

Optionally, the second pretreatment composition may further comprise a source of phosphate ions. For clarity, when used herein, “phosphate ions” refers to phosphate ions that derive from or originate from inorganic phosphate compounds. For example, in some instances, phosphate ions may be present in an amount of greater than 5 ppm, based on total weight of the pretreatment composition, such as 10 ppm, such as 20 ppm. In some instances, phosphate ions may be present in an amount of no more than 60 ppm, based on total weight of the second pretreatment composition, such as no more than 40 ppm, such as no more than 30 ppm. In some instances, phosphate ions may be present in an amount of from 5 ppm to 60 ppm, based on total weight of the pretreatment composition, such as from 10 ppm to 40 ppm, such as from 20 ppm to 30 ppm.

The pH of the second pretreatment composition may be 6.5 or less, such as 5.5 or less, such as 4.5 or less, such as 3.5 or less. The pH of the pretreatment composition may, in some instances, be 2.0 to 6.5, such as 3 to 4.5, and may be adjusted using, for example, any acid and/or base as is necessary. The pH of the second pretreatment composition may be maintained through the inclusion of an acidic material, including soluble water and/or water dispersible acids, such as nitric acid, sulfuric acid, and/or phosphoric acid. The pH of the composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

The second pretreatment composition also may further comprise a resinous binder. Suitable resins include reaction products of one or more alkanolamines and an epoxy-functional material containing at least two epoxy groups, such as those disclosed in U.S. Pat. No. 5,653,823. In some cases, such resins contain beta hydroxy ester, imide, or sulfide functionality, incorporated by using dimethylolpropionic acid, phthalimide, or mercaptoglycerine as an additional reactant in the preparation of the resin. Alternatively, the reaction product can for instance be that of the diglycidyl ether of Bisphenol A (commercially available e.g. from Shell Chemical Company as EPON 880), dimethylol propionic acid, and diethanolamine in a 0.6 to 5.0:0.05 to 5.5:1 mole ratio. Other suitable resinous binders include water soluble and water dispersible polyacrylic acids such as those disclosed in U.S. Pat. Nos. 3,912,548 and 5,328,525; phenol formaldehyde resins such as those described in U.S. Pat. No. 5,662,746; water soluble polyamides such as those disclosed in WO 95/33869; copolymers of maleic or acrylic acid with allyl ether such as those described in Canadian patent application 2,087,352; and water soluble and dispersible resins including epoxy resins, aminoplasts, phenol-formaldehyde resins, tannins, and polyvinyl phenols such as those discussed in U.S. Pat. No. 5,449,415.

The resinous binder often may be present in the second pretreatment composition in an amount of 0.005 percent to 30 percent by weight, such as 0.5 to 3 percent by weight, based on the total weight of the second pretreatment composition. Alternatively, the second pretreatment composition may be substantially free or, in some cases, completely free of any resinous binder. As used herein, the term “substantially free”, when used with reference to the absence of resinous binder in the second pretreatment composition, means that, if present at all, any resinous binder is present in the second pretreatment composition in a trace amount of less than 0.005 percent by weight, based on total weight of the composition. As used herein, the term “completely free” means that there is no resinous binder in the pretreatment composition at all.

The second pretreatment composition may comprise an aqueous medium and may optionally contain other materials such as nonionic surfactants and auxiliaries conventionally used in the art of pretreatment compositions. In the aqueous medium, water dispersible organic solvents, for example, alcohols with up to about 8 carbon atoms such as methanol, isopropanol, and the like, may be present; or glycol ethers such as the monoalkyl ethers of ethylene glycol, diethylene glycol, or propylene glycol, and the like. When present, water dispersible organic solvents are typically used in amounts up to about ten percent by volume, based on the total volume of aqueous medium.

Other optional materials include surfactants that function as defoamers or substrate wetting agents. Anionic, cationic, amphoteric, and/or nonionic surfactants may be used. Defoaming surfactants may optionally be present at levels up to 1 weight percent, such as up to 0.1 percent by weight, and wetting agents are typically present at levels up to 2 percent, such as up to 0.5 percent by weight, based on the total weight of the pretreatment composition.

The second pretreatment composition may comprise a carrier, often an aqueous medium, so that the composition is in the form of a solution or dispersion of the Group IVB metal in the carrier. For example, the second pretreatment composition may be an aqueous composition. The solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion when applied to the metal substrate is at a temperature ranging from 40° F. to 185° F., such as 60° F. to 110° F., such as 70° F. to 90° F. For example, the pretreatment process may be carried out at ambient or room temperature. The contact time is often from 5 seconds to 15 minutes, such as 10 seconds to 10 minutes, such as 15 seconds to 3 minutes.

Following the contacting with the second pretreatment composition, the substrate may be rinsed with tap water, deionized water, and/or an aqueous solution of rinsing agents in order to remove any residue. The substrate optionally may be air dried at room temperature or may be dried with hot air, for example, by using an air knife, by flashing off the water by brief exposure of the substrate to a high temperature, such as by drying the substrate in an oven at 15° C. to 200° C., such as 20° C. to 90° C., or in a heater assembly using, for example, infrared heat, such as for 10 minutes at 70° C., or by passing the substrate between squeegee rolls. Following the contacting with the second pretreatment composition, the substrate optionally may be rinsed with tap water, deionized water, and/or an aqueous solution of rinsing agents in order to remove any residue and then optionally may be dried, for example air dried or dried with hot air as described in the preceding sentence.

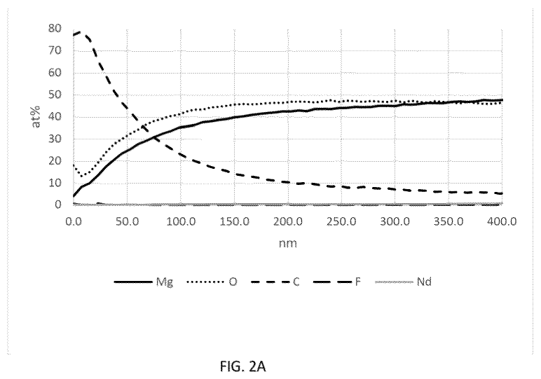

The thickness of the pretreatment coating formed on a substrate treated according to the system or method of the present invention may for instance be less than 3 micrometer, for example from 1 to 1000 nanometers, or from 20 to 500 nanometers. Pretreatment thickness can be determined using a handful of analytical techniques including but not limited to XPS depth profiling or TEM. See FIG. 2.

### Third Pretreatment Compositions

As mentioned above, the third pretreatment composition may comprise a lanthanide series metal and an oxidizing agent. At least a portion of the substrate surface may be contacted with the third conversion composition following contacting with the first conversion composition.

The lanthanide series metal may, for example, comprise cerium, praseodymium, terbium, or combinations thereof. The lanthanide series metal may be present in the third pretreatment composition as a salt.

The lanthanide series metal may be present in the third pretreatment composition in an amount of at least 5 ppm based on total weight of the third pretreatment composition, such as at least 10 ppm, such as at least 20 ppm, such as at least 30 ppm, such as at least 40 ppm, such as at least 50 ppm, and may be present in the third pretreatment composition in an amount of no more than 25,000 ppm based on total weight of the third pretreatment composition, such as no more than 10,000 ppm, such as no more than 5,000 ppm, such as no more than 3,000 ppm, such as no more than 1,000 ppm, such as no more than 500 ppm. The lanthanide series metal may be present in the third pretreatment composition in an amount of 5 ppm to 25,000 ppm based on total weight of the third pretreatment composition, such as 10 ppm to 10,000 ppm, such as 20 ppm to 5,000 ppm, such as 30 ppm to 3,000 ppm, such as 40 ppm to 1,000 ppm, such as 50 ppm to 500 ppm.

The third pretreatment composition may further comprise an anion that may be suitable for forming a salt with the lanthanide series metal, such as a halogen, a nitrate, a sulfate, a phosphate, a silicate (orthosilicates and metasilicates), carbonates, hydroxides, and the like. In examples, the halogen may exclude fluoride, since lanthanide metal fluoride complexes are generally very insoluble in water. The anion may be present in the third pretreatment composition, if at all, in an amount of at least 2 ppm based on total weight of the third pretreatment composition, such as at least 50 ppm, such as at least 150 ppm, and may be present in an amount of no more than 25,000 ppm based on total weight of the third pretreatment composition, such as no more than 18,500 ppm, such as no more than 5000 ppm. The anion may be present in the third pretreatment composition, if at all, in an amount of 2 ppm to 25,000 ppm based on total weight of the third pretreatment composition, such as 50 ppm to 18,500 ppm, such as 150 ppm to 5000 ppm.

The third pretreatment composition may further comprise an oxidizing agent. Non-limiting examples of the oxidizing agent include peroxides, persulfates, perchlorates, hypochlorite, nitric acid, sparged oxygen, bromates, peroxi-benzoates, ozone, or combinations thereof. The oxidizing agent may be present in an amount of at least 25 ppm, such as at least 150 ppm, such as at least 500 ppm, based on total weight of the third pretreatment composition, and may be present in an amount of no more than 13,000 ppm, such as no more than 10,000 ppm, such as no more than 3,000 ppm, based on total weight of the third pretreatment composition. The oxidizing agent may be present in the third pretreatment composition, if at all, in an amount of 25 ppm to 13,000 ppm, such as such as 150 ppm to 10,000 ppm, such as 500 ppm to 3,000 ppm, based on total weight of the third pretreatment composition.

As discussed above with respect to the first pretreatment composition, the third pretreatment composition may exclude chromium or chromium-containing compounds. That is, the third pretreatment composition and/or coatings or layers deposited from the third pretreatment composition may be substantially free, may be essentially free, and/or may be completely free of such chromium or chromium-containing compounds.

As discussed above with respect to the first pretreatment composition, the third pretreatment composition may, in some instances, exclude phosphate ions or phosphate-containing compounds and/or the formation of sludge. That is, the third pretreatment composition and/or coatings or layers deposited from the third pretreatment composition may be substantially free, or essentially free, or completely free, of phosphate ions or phosphate-containing compounds.

Optionally, the third pretreatment composition may contain no more than one lanthanide series metal cation, such that the third pretreatment composition may contain one lanthanide series metal cation and may be substantially free or essentially free or completely free of more than one lanthanide series metal cations.

The third pretreatment composition may be substantially free, essentially free, or completely free of gelatin.

The third pretreatment composition may be substantially free, essentially free, or completely free of lanthanide oxide such that the bath containing the third pretreatment composition is substantially, essentially, or completely free of lanthanide oxide.

The third pretreatment composition optionally may be substantially free, essentially free, or completely free of copper.

The pH of the third pretreatment composition may be 2.0 to 5.5, such as 2.5 to 4.5, such as 3 to 4, and may be adjusted using, for example, any acid and/or base as is necessary. The pH of the third pretreatment composition may be maintained through the inclusion of an acidic material, including water soluble and/or water dispersible acids, such as nitric acid, sulfuric acid, and/or organic acids, including by way of non-limiting examples, C₁-C₆ acids, such as formic acid, acetic acid, and/or propionic acid. The pH of the third pretreatment composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

The third pretreatment composition may comprise a carrier, often an aqueous medium, so that the composition is in the form of a solution or dispersion of the lanthanide series metal cation, such as the lanthanide series metal salt, in the carrier. For example, the third pretreatment composition may be an aqueous composition. The solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion when applied to the metal substrate may be at a temperature ranging from 20° C. to 50° C., such as 25° C. to 40° C. For example, the pretreatment process may be carried out at ambient or room temperature. The contact time is often from 15 seconds to 5 minutes, such as 30 seconds to 4 minutes, such as 1 minute to 3 minutes.

### Cleaners

The system of the present invention optionally may further comprise a cleaner. At least a portion of the substrate surface may be cleaned prior to contacting at least a portion of the substrate surface with one of the pretreatment compositions described above in order to remove grease, dirt, and/or other extraneous matter. At least a portion of the surface of the substrate may be cleaned by physical and/or chemical means, such as mechanically abrading the surface and/or cleaning/degreasing the surface with commercially available alkaline or acidic cleaning agents that are well known to those skilled in the art. Examples of alkaline cleaners suitable for include Chemkleen™ 166HP, 166M/C, 177, 181ALP, 490MX, 2010LP, and Surface Prep 1 (SP1), Ultrax 32, Ultrax 97, Ultrax 29, and Ultrax92D, each of which are commercially available from PPG Industries, Inc. (Cleveland, OH), and any of the DFM Series, RECC 1001, and 88X1002 cleaners (commercially available from PRC-DeSoto International, Sylmar, CA), and Turco 4215-NCLT and Ridolene (commercially available from Henkel Technologies, Madison Heights, MI). Examples of acidic cleaners suitable for use include Acid Metal Cleaner (AMC) 23, AMC 239, AMC 240, and AMC 533, AMC66AW, and acetic acid. Such cleaners are often preceded and/or followed by a water rinse, such as with tap water, distilled water, or combinations thereof.

Following the cleaning step(s), the substrate optionally may be rinsed with tap water, deionized water, and/or an aqueous solution of rinsing agents in order to remove any residue. The wet substrate surface may be treated with one of the pretreatment compositions described above or the substrate may be dried prior to treating the substrate surface, such as air dried, for example, by using an air knife, by flashing off the water by brief exposure of the substrate to a high temperature, such as 15° C. to 100° C., such as 20° C. to 90° C., or in a heater assembly using, for example, infrared heat, such as for 10 minutes at 70° C., or by passing the substrate between squeegee rolls.

### Film-Forming Resins

As discussed above, the present invention is directed to a system for treating a metal substrate comprising, or consisting essentially of, or consisting of, the first and second or third pretreatment compositions described above. Optionally, the system may further comprise a coating composition. The coating composition may comprise, or consist essentially of, or consist of, a film-forming resin. Any suitable technique may be used to deposit such a coating composition onto the substrate, including, for example, brushing, dipping, flow coating, spraying and the like. Optionally, however, as described in more detail below, such depositing of a coating composition may comprise an electrocoating step wherein an electrodepositable coating composition is deposited onto a metal substrate by electrodeposition. In certain other instances, as described in more detail below, such depositing of a coating composition comprises a powder coating step. In still other instances, the coating composition may be a liquid coating composition.

The coating composition may comprise a thermosetting film-forming resin or a thermoplastic film-forming resin. As used herein, the term “film-forming resin” refers to resins that can form a self-supporting continuous film on at least a horizontal surface of a substrate upon removal of any diluents or carriers present in the composition and/or upon curing at ambient or elevated temperature. Conventional film-forming resins that may be used include, without limitation, those typically used in automotive OEM coating compositions, automotive refinish coating compositions, industrial coating compositions, architectural coating compositions, coil coating compositions, and aerospace coating compositions, among others. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. Curing or crosslinking reactions also may be carried out under ambient conditions. Once cured or crosslinked, a thermosetting resin will not melt upon the application of heat and is insoluble in solvents. As used herein, the term “thermoplastic” refers to resins that comprise polymeric components that are not joined by covalent bonds and thereby can undergo liquid flow upon heating and are soluble in solvents.

As previously indicated, the coating composition may be an electrodepositable coating composition comprising a water-dispersible, ionic salt group-containing film-forming resin that may be deposited onto the substrate by an electrocoating step wherein the electrodepositable coating composition is deposited onto the metal substrate under the influence of an applied electrical potential, i.e., by electrodeposition. The ionic salt group-containing film-forming polymer may comprise a cationic salt group containing film-forming polymer for use in a cationic electrodepositable coating composition. As used herein, the term “cationic salt group-containing film-forming polymer” refers to polymers that include at least partially neutralized cationic groups, such as sulfonium groups and ammonium groups, that impart a positive charge. The cationic salt group-containing film-forming polymer may comprise active hydrogen functional groups, including, for example, hydroxyl groups, primary or secondary amino groups, and thiol groups. Cationic salt group-containing film-forming polymers that comprise active hydrogen functional groups may be referred to as active hydrogen-containing, cationic salt group-containing film-forming polymers. Examples of polymers that are suitable for use as the cationic salt group-containing film-forming polymer include, but are not limited to, alkyd polymers, acrylics, polyepoxides, polyamides, polyurethanes, polyureas, polyethers, and polyesters, among others. The cationic salt group-containing film-forming polymer may be present in the cationic electrodepositable coating composition in an amount of 40% to 90% by weight, such as 50% to 80% by weight, such as 60% to 75% by weight based on the total weight of the resin solids of the electrodepositable coating composition. As used herein, the “resin solids” include the ionic salt group-containing film-forming polymer, curing agent (as discussed below), and any additional water-dispersible non-pigmented component(s) present in the electrodepositable coating composition.

Alternatively, the ionic salt group containing film-forming polymer may comprise an anionic salt group containing film-forming polymer for use in an anionic electrodepositable coating composition. As used herein, the term “anionic salt group containing film-forming polymer” refers to an anionic polymer comprising at least partially neutralized anionic functional groups, such as carboxylic acid and phosphoric acid groups that impart a negative charge. The anionic salt group-containing film-forming polymer may comprise active hydrogen functional groups. Anionic salt group-containing film-forming polymers that comprise active hydrogen functional groups may be referred to as active hydrogen-containing, anionic salt group-containing film-forming polymers. The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Patent Application Publication No. 2009-0045071 at [0004]-[0015] and U.S. patent application Ser. No. 13/232,093 at [0014]-[0040], the cited portions of which being incorporated herein by reference. The anionic salt group-containing film-forming polymer may be present in the anionic electrodepositable coating composition in an amount 50% to 90%, such as 55% to 80%, such as 60% to 75% based on the total weight of the resin solids of the electrodepositable coating composition.

The electrodepositable coating composition may further comprise a curing agent. The curing agent may comprise functional groups that are reactive with the functional groups, such as active hydrogen groups, of the ionic salt group-containing film-forming polymer to effectuate cure of the coating composition to form a coating. Non-limiting examples of suitable curing agents are at least partially blocked polyisocyanates, aminoplast resins and phenoplast resins, such as phenolformaldehyde condensates including allyl ether derivatives thereof. The curing agent may be present in the cationic electrodepositable coating composition in an amount of 10% to 60% by weight, such as 20% to 50% by weight, such as 25% to 40% by weight based on the total weight of the resin solids of the electrodepositable coating composition. Alternatively, the curing agent may be present in the anionic electrodepositable coating composition in an amount of 10% to 50% by weight, such as 20% to 45% by weight, such as 25% to 40% by weight based on the total weight of the resin solids of the electrodepositable coating composition.

The electrodepositable coating composition may further comprise other optional ingredients, such as a pigment composition and, if desired, various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof.

The electrodepositable coating composition may comprise water and/or one or more organic solvent(s). Water can, for example, be present in amounts of 40% to 90% by weight, such as 50% to 75% by weight based on total weight of the electrodepositable coating composition. If used, the organic solvents may typically be present in an amount of less than 10% by weight, such as less than 5% by weight based on total weight of the electrodepositable coating composition. The electrodepositable coating composition may in particular be provided in the form of an aqueous dispersion. The total solids content of the electrodepositable coating composition may be from 1% to 50% by weight, such as 5% to 40% by weight, such as 5% to 20% by weight based on the total weight of the electrodepositable coating composition. As used herein, “total solids” refers to the non-volatile content of the electrodepositable coating composition, i.e., materials which will not volatilize when heated to 110° C. for 15 minutes.

The cationic electrodepositable coating composition may be deposited upon an electrically conductive substrate by placing the composition in contact with an electrically conductive cathode and an electrically conductive anode, with the surface to be coated being the cathode. Alternatively, the anionic electrodepositable coating composition may be deposited upon an electrically conductive substrate by placing the composition in contact with an electrically conductive cathode and an electrically conductive anode, with the surface to be coated being the anode. An adherent film of the electrodepositable coating composition is deposited in a substantially continuous manner on the cathode or anode, respectively, when a sufficient voltage is impressed between the electrodes. The applied voltage may be varied and can be, for example, as low as one volt to as high as several thousand volts, such as between 50 and 500 volts. Current density is usually between 1.0 ampere and 15 amperes per square foot (10.8 to 161.5 amperes per square meter) and tends to decrease quickly during the electrodeposition process, indicating formation of a continuous self-insulating film.

Once the cationic or anionic electrodepositable coating composition is electrodeposited over at least a portion of the electroconductive substrate, the coated substrate may be heated to a temperature and for a time sufficient to cure the electrodeposited coating on the substrate. For cationic electrodeposition, the coated substrate may be heated to a temperature ranging from 230° F. to 450° F. (110° C. to 232.2° C.), such as from 275° F. to 400° F. (135° C. to 204.4° C.), such as from 300° F. to 360° F. (149° C. to 180° C.). For anionic electrodeposition, the coated substrate may be heated to a temperature ranging from 200° F. to 450° F. (93° C. to 232.2° C.), such as from 275° F. to 400° F. (135° C. to 204.4° C.), such as from 300° F. to 360° F. (149° C. to 180° C.), such as 200° F. to 210.2° F. (93° C. to 99° C.). The curing time may be dependent upon the curing temperature as well as other variables, for example, the film thickness of the electrodeposited coating, level and type of catalyst present in the composition and the like. For example, the curing time can range from 10 minutes to 60 minutes, such as 20 to 40 minutes. The thickness of the resultant cured electrodeposited coating may range from 10 to 50 microns.

Alternatively, as mentioned above, after the substrate has been contacted with the pretreatment compositions as described above, a powder coating composition may then be deposited onto at least a portion of the pretreated substrate surface. As used herein, “powder coating composition” refers to a coating composition in the form of a co-reactable solid in particulate form which is substantially or completely free of water and/or solvent. Accordingly, the powder coating composition disclosed herein is not synonymous to waterborne and/or solvent-borne coating compositions known in the art. The powder coating composition may comprise (a) a film forming polymer having a reactive functional group; and (b) a curing agent having a functional group that is reactive with the functional group of the film-forming polymer. Examples of powder coating compositions that may be used in the present invention include the polyester-based ENVIROCRON line of powder coating compositions (commercially available from PPG Industries, Inc.) or epoxy-polyester hybrid powder coating compositions. Alternative examples of powder coating compositions that may be used include low temperature cure thermosetting powder coating compositions comprising (a) at least one tertiary aminourea compound, at least one tertiary aminourethane compound, or mixtures thereof, and (b) at least one film-forming epoxy-containing resin and/or at least one siloxane-containing resin (such as those described in U.S. Pat. No. 7,470,752, assigned to PPG Industries, Inc. and incorporated herein by reference); curable powder coating compositions generally comprising (a) at least one tertiary aminourea compound, at least one tertiary aminourethane compound, or mixtures thereof, and (b) at least one film-forming epoxy-containing resin and/or at least one siloxane-containing resin (such as those described in U.S. Pat. No. 7,432,333, assigned to PPG Industries, Inc. and incorporated herein by reference); and those comprising a solid particulate mixture of a reactive group-containing polymer having a T_{g} of at least 30° C. (such as those described in U.S. Pat. No. 6,797,387, assigned to PPG Industries, Inc. and incorporated herein by reference). The powder coating compositions are often applied by spraying, electrostatic spraying, or by the use of a fluidized bed. Other standard methods for coating application of the powder coating also can be employed such as brushing, dipping or flowing. After application of the powder coating composition, the coating is often heated to cure the deposited composition. The heating or curing operation is often carried out at a temperature in the range of from 130° C. to 220° C., such as from 170° C. to 190° C., for a period of time ranging from 10 minutes to 30 minutes, such 15 minutes to 25 minutes. The thickness of the resultant film is from 50 microns to 125 microns.

As mentioned above, after the substrate has been contacted with the pretreatment compositions as described above, a liquid coating composition may then be applied or deposited onto at least a portion of the substrate surface. As used herein, “liquid coating composition” refers to a coating composition which contains a portion of water and/or solvent that may be substantially or completely removed from the composition upon drying and/or curing. Accordingly, the liquid coating composition disclosed herein is synonymous to waterborne and/or solvent-borne coating compositions known in the art.

The liquid coating composition may comprise, for example, (a) a film forming polymer having a reactive functional group; and (b) a curing agent having a functional group that is reactive with the functional group of the film-forming polymer. In other examples, the liquid coating may contain a film forming polymer that may react with oxygen in the air or coalesce into a film with the evaporation of water and/or solvents. These film-forming mechanisms may require or be accelerated by the application of heat or some type of radiation such as Ultraviolet or Infrared. Examples of liquid coating compositions that may be used include the SPECTRACRON® line of solvent-based coating compositions, the AQUACRON® line of water-based coating compositions, and the RAYCRON® line of UV cured coatings (all commercially available from PPG Industries, Inc.). Suitable film forming polymers that may be used in the liquid coating composition may comprise a (poly)ester, an alkyd, a (poly)urethane, an isocyanurate, a (poly)urea, a (poly)epoxy, an anhydride, an acrylic, a (poly)ether, a (poly)sulfide, a (poly)amine, a (poly)amide, (poly)vinyl chloride, (poly)olefin, (poly)vinylidene fluoride, (poly)siloxane, or combinations thereof.

The film-forming resin may, in examples, be a primer composition and/or a topcoat composition. The primer and/or topcoat compositions may be, for example, chromate-based primers and/or advanced performance topcoats. The primer coat can be a conventional chromate-based primer coat, such as those available from PPG Industries, Inc. (product code 44GN072), or a chrome-free primer such as those available from PPG (DESOPRIME CA7502, DESOPRIME CA7521, Deft 02GN083, Deft 02GN084). Alternately, the primer coat can be a chromate-free primer coat, such as the coating compositions described in U.S. patent application Ser. No. 10/758,973, titled “CORROSION RESISTANT COATINGS CONTAINING CARBON”, and U.S. patent application Ser. Nos. 10/758,972, and 10/758,972, both titled “CORROSION RESISTANT COATINGS”, all of which are incorporated herein by reference, and other chrome-free primers that are known in the art, and which can pass the military requirement of MIL-PRF-85582 Class N or MIL-PRF-23377 Class N may also be used with the current invention.

As mentioned above, the substrate of the present invention also may comprise a topcoat. As used herein, the term “topcoat” refers to a mixture of binder(s) which can be an organic or inorganic based polymer or a blend of polymers, typically at least one pigment, can optionally contain at least one solvent or mixture of solvents, and can optionally contain at least one curing agent. A topcoat is typically the coating layer in a single or multi-layer coating system whose outer surface is exposed to the atmosphere or environment, and its inner surface is in contact with another coating layer or polymeric substrate. Examples of suitable topcoats include those conforming to MIL-PRF-85285D, such as those available from PPG (Deft 03W127A and Deft 03GY292). The topcoat may be an advanced performance topcoat, such as those available from PPG (Defthane® ELT.TM. 99GY001 and 99W009). However, other topcoats and advanced performance topcoats can be used as will be understood by those of skill in the art with reference to this disclosure.

The metal substrate also may comprise a self-priming topcoat, or an enhanced self-priming topcoat. The term “self-priming topcoat”, also referred to as a “direct to substrate” or “direct to metal” coating, refers to a mixture of a binder(s), which can be an organic or inorganic based polymer or blend of polymers, typically at least one pigment, can optionally contain at least one solvent or mixture of solvents, and can optionally contain at least one curing agent. The term “enhanced self-priming topcoat”, also referred to as an “enhanced direct to substrate coating” refers to a mixture of functionalized fluorinated binders, such as a fluoroethylene-alkyl vinyl ether in whole or in part with other binder(s), which can be an organic or inorganic based polymer or blend of polymers, typically at least one pigment, can optionally contain at least one solvent or mixture of solvents, and can optionally contain at least one curing agent. Examples of self-priming topcoats include those that conform to TT-P-2756A. Examples of self-priming topcoats include those available from PPG (03W169 and 03GY369), and examples of enhanced self-priming topcoats include Defthane® ELT™/ESPT and product code number 97GY121, available from PPG. However, other self-priming topcoats and enhanced self-priming topcoats can be used in the coating system as will be understood by those of skill in the art with reference to this disclosure.

The self-priming topcoat and enhanced self-priming topcoat may be applied directly to the pretreated substrate. The self-priming topcoat and enhanced self-priming topcoat can optionally be applied to an organic or inorganic polymeric coating, such as a primer or paint film. The self-priming topcoat layer and enhanced self-priming topcoat is typically the coating layer in a single or multi-layer coating system where the outer surface of the coating is exposed to the atmosphere or environment, and the inner surface of the coating is typically in contact with the substrate or optional polymer coating or primer.

The topcoat, self-priming topcoat, and enhanced self-priming topcoat can be applied to the pretreated substrate, in either a wet or “not fully cured” condition that dries or cures over time, that is, solvent evaporates and/or there is a chemical reaction. The coatings can dry or cure either naturally or by accelerated means for example, an ultraviolet light cured system to form a film or “cured” paint.

In addition, a colorant and, if desired, various additives such as surfactants, wetting agents or catalyst can be included in the coating composition (electrodepositable, powder, or liquid). As used herein, the term “colorant” means any substance that imparts color and/or other opacity and/or other visual effect to the composition. Example colorants include pigments, dyes and tints, such as those used in the paint industry and/or listed in the Dry Color Manufacturers Association (DCMA), as well as special effect compositions. In general, the colorant can be present in the coating composition in any amount sufficient to impart the desired visual and/or color effect. The colorant may comprise from 1 to 65 weight percent, such as from 3 to 40 weight percent or 5 to 35 weight percent, with weight percent based on the total weight of the composition.

### Methods

The present invention also is directed to methods for treating a metal substrate. In examples, the method of treating may comprise, or may consist essentially of, or may consist of, contacting at least a portion of a substrate surface with one of the first pretreatment compositions disclosed herein. For example, the first pretreatment composition may comprise, or consist essentially of, or consist of, a fluorometallic acid comprising a Group IVA metal and/or a Group IVB metal and free fluoride in an amount of 10 ppm to 500 ppm based on total weight of the first pretreatment composition. In examples, the method may comprise, or consist essentially of, or consist of: contacting at least a portion of a substrate surface with one of the first pretreatment compositions disclosed herein; and contacting at least a portion of the surface with one of the second pretreatment compositions disclosed herein; or contacting at least a portion of the surface with one of the third pretreatment compositions disclosed herein. For example, the second composition may comprise, or consist essentially of, or consist of, a Group IVB metal and free fluoride in an amount of 15 ppm to 200 ppm based on total weight of the second pretreatment composition. For example, the third pretreatment composition may comprise, or consist essentially of, or consist of, a lanthanide series metal and an oxidizing agent. The method also may further comprise contacting at least a portion of the substrate surface with a cleaner composition and/or a film-forming resin.

### Treated Substrates

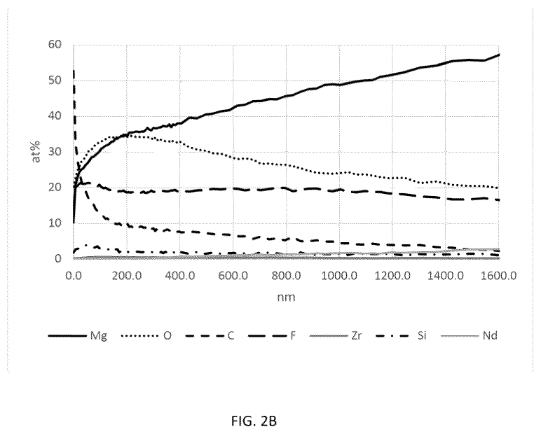

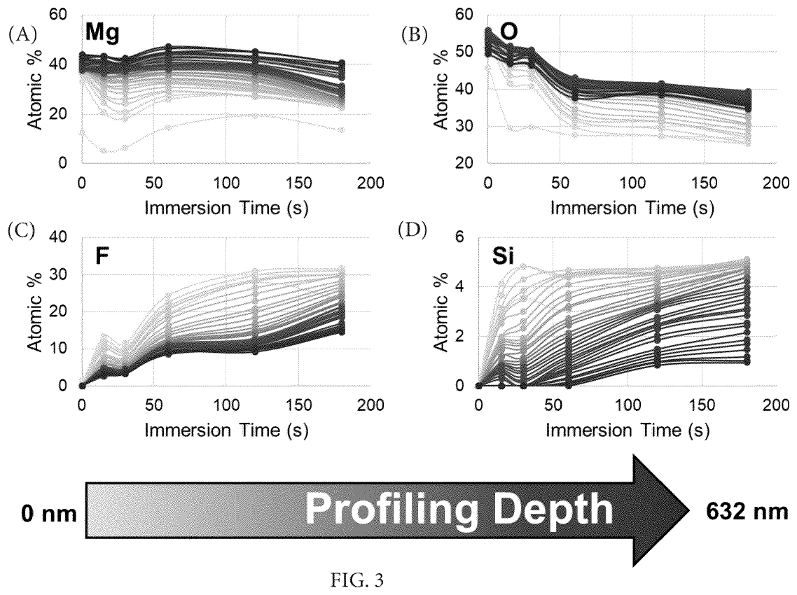

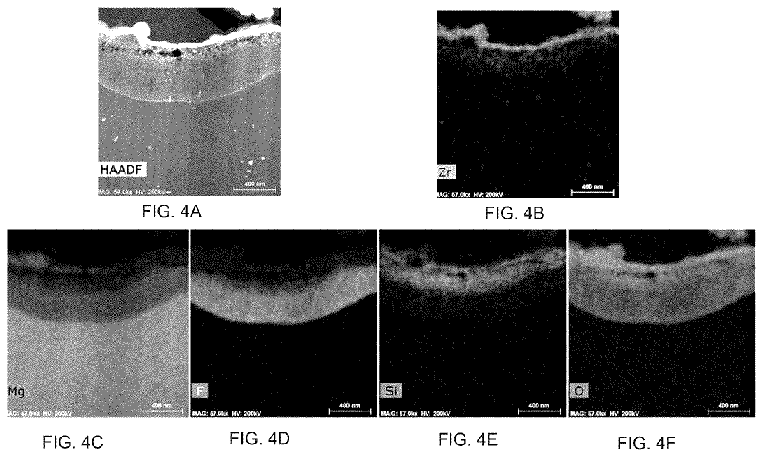

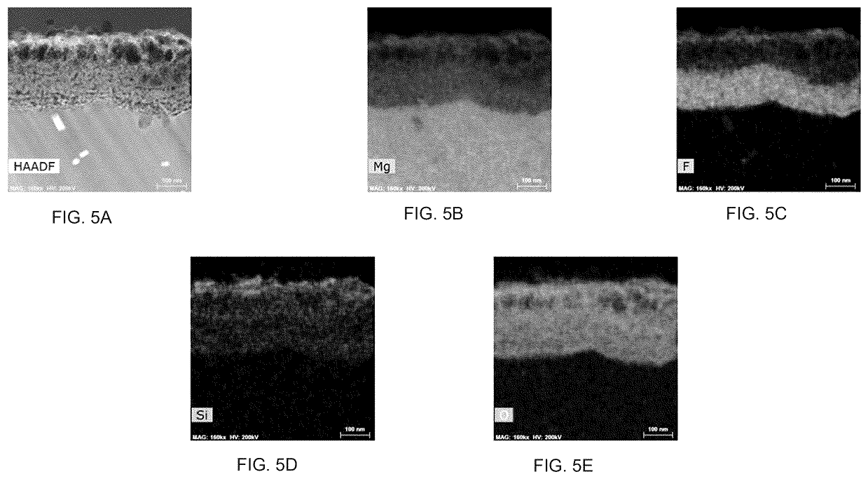

The present invention also may comprise a magnesium or magnesium alloy substrate comprising a bilayer. See FIG. 2B, FIG. 3C-3D, FIG. 4, and FIG. 5. The bilayer may comprise a first layer comprising silicon from an air/substrate interface to at least 500 nm below the air/substrate interface, such as at to at least 800 nm below the air/substrate interface, such as at least 1000 nm below the air/substrate interface as measured by XPS depth profiling using a Physical Electronics VersaProbe II instrument equipped with a monochromatic Al ka x-ray source (hv=1,486.7 eV and a concentric hemispherical analyzer. The first layer of the bilayer may comprise silicon in an amount of 1 atomic % to 10 atomic % as measured by XPS depth profiling (described above), such as 1 atomic % to 7.5 atomic %, such as 1 atomic % to 5 atomic %. The bilayer also may comprise a second layer comprising fluoride from an air/substrate interface to at least 400 nm below the air/substrate interface as measured by XPS depth profiling (described above), such as to least 800 nm below the air/substrate interface, such as at least 1000 nm below the air/substrate. The second layer of the bilayer may comprise fluoride in an amount of 1 atomic % to 50 atomic % as measured by XPS depth profiling (described above), such as 1 atomic % to 40 atomic %, such as 1 atomic % to 30 atomic %. The identification of this bilayer on a magnesium or a magnesium alloy substrate was surprising and unexpected.

The bilayer may be formed on a magnesium or a magnesium alloy substrate following treatment with one of the first pretreatment compositions described herein and/or according to one of the methods described herein. As shown in FIG. 2A, the bilayer is absent on substrates not treated with one of the first pretreatment compositions of the present invention (e.g., treated with the second pretreatment composition). The formation of the bilayer following treatment with the first pretreatment composition was a surprising and unexpected result.

In addition, the substrate treated with one of the pretreatment compositions described herein may demonstrate improved corrosion resistance compared to a substrate not treated with one of the first pretreatment compositions of the present invention (e.g., treated with the second pretreatment composition). In examples, such a substrate, when exposed to Cycle B corrosion testing for at least 9 cycles, may have an average scribe creep of less than 1.7 mm per cycle, such as less than 1.5 mm per cycle, such as less than 1.0 mm per cycle, such as less than 0.5 mm per cycle. In examples, such a substrate, when exposed to B117 salt spray testing for at least 7 days, may have an average scribe creep of less than 2.5 mm per day, such as less than 2.0 mm per day, such as less than 1.5 mm per day, such as less than 1.0 mm per day, such as less than 0.5 mm per day.

The present invention also is directed to substrates treated with one of the systems and/or methods disclosed herein. That is, in examples, the present invention is directed to a substrate treated with a system comprising, or consisting essentially of, or consisting of: a first pretreatment composition comprising a fluorometallic acid comprising, or consisting essentially of, or consisting of, a Group IVA metal and/or a Group IVB metal and free fluoride in an amount of 10 ppm to 500 ppm based on total weight of the first pretreatment composition and having a pH of 1.0 to 4.0; and a second pretreatment composition comprising, or consisting essentially of, or consisting of, a Group IVB metal and free fluoride in an amount of 15 ppm to 200 ppm based on total weight of the second pretreatment composition; or a third pretreatment comprising, or consisting essentially of, or consisting of, a lanthanide series metal and oxidizing agent. In other examples, the present invention is directed to a subtracted treated by a method comprising, or consisting essentially of, or consisting of: contacting at least a portion of a surface of the substrate with a first pretreatment composition comprising a fluorometallic acid comprising, or consisting essentially of, or consisting of, a Group IVA metal and/or a Group IVB metal and free fluoride in an amount of 10 ppm to 500 ppm based on total weight of the first pretreatment composition and having a pH of 1.0 to 4.0; and contacting at least a portion of the surface with a second pretreatment composition comprising, or consisting essentially of, or consisting of, a Group IVB metal and free fluoride in an amount of 15 ppm to 200 ppm based on total weight of the second pretreatment composition; or contacting at least a portion of the surface with a third pretreatment comprising, or consisting essentially of, or consisting of, a lanthanide series metal and oxidizing agent. In examples, the treated substrate may comprise a layer on at least a portion of the substrate, wherein the layer may be formed from one of the first, second or third pretreatment compositions described herein. In examples, the treated substrate, when exposed to Cycle B or B117 Salt Spray corrosion testing (as described in the Examples), may, for example, have an average scribe creep (per cycle, mm) that is decreased by at least 5% compared to scribe creep (per cycle, mm) of a substrate treated with the second pretreatment or the third pretreatment composition but not the first pretreatment composition. In examples, the substrate, when exposed to Cycle B corrosion testing for at least 9 cycles (as described in the Examples), may, for example, have an average scribe creep of less than 1.7 mm per cycle. In examples, the substrate, when exposed to B117 salt spray testing for at least 7 days (as described in the Examples), may, for example, have an average scribe creep of less than 2.5 mm per day. These improvements in corrosion performance compared to substrates not treated with the first pretreatment composition were surprising and unexpected. In examples, the substrate may comprise the bilayer described above.

Whereas specific aspects of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims and aspects appended and any and all equivalents thereof.

### Aspects of the Invention

In the following, some non-limiting aspects of the present invention are summarized:

Aspect 1. A system for treating a magnesium or a magnesium alloy substrate comprising:
a first pretreatment composition comprising a fluorometallic acid comprising a Group IVA metal and/or a Group IVB metal and free fluoride in an amount of 10 ppm to 500 ppm based on total weight of the first pretreatment composition and having a pH of 1.0 to 4.0; and
a second pretreatment composition comprising a Group IVB metal and free fluoride in an amount of 15 ppm to 200 ppm based on total weight of the second pretreatment composition; or
a third pretreatment composition comprising a lanthanide series metal and oxidizing agent.

Aspect 2. The system of Aspect 1, wherein the fluorometallic acid comprises hexafluorosilicic acid, hexafluorozirconic acid, hexafluorotitanic acid, hexafluoroferric acid, hexafluoroaluminic acid, or combinations thereof.

Aspect 3. The system of Aspect 1 or Aspect 2, wherein the Group IVA metal is present in the first pretreatment composition in an amount of 10 ppm to 1,500 ppm based on total weight of the first pretreatment composition.

Aspect 4. The system of any of the preceding Aspects, wherein the Group IVB metal is present in the first pretreatment composition in an amount of 200 ppm to 5,000 ppm based on total weight of the first pretreatment composition.

Aspect 5. The system of any of the preceding Aspects, wherein the free fluoride derives from the fluorometallic acid.

Aspect 6. The system of any of the preceding Aspects, wherein the first pretreatment composition further comprises a fluoride source in addition to the fluorometallic acid and/or a hydroxide source.

Aspect 7. The system of any of the preceding Aspects, wherein the Group IVB metal is present in the second pretreatment composition in an amount of 20 ppm to 1,000 ppm based on total weight of the second pretreatment composition.

Aspect 8. The system of any of the preceding Aspects, wherein the second pretreatment composition further comprises an electropositive metal, a Group IA metal, a Group VIB metal, a Group VIIIB metal, and/or an oxidizing agent.

Aspect 9. The system of Aspect 8, wherein the electropositive metal is present in the second pretreatment composition in an amount of 2 ppm to 100 ppm based on total weight of the second pretreatment composition, the Group IA metal is present in the second pretreatment composition in an amount of 2 ppm to 500 ppm based on total weight of the second pretreatment composition, the Group VIB metal is present in the second pretreatment composition in an amount of 5 ppm to 500 ppm based on total weight of the second pretreatment composition, the Group VIIIB metal is present in the second pretreatment composition in an amount of 0.1 ppm to 50 ppm based on total weight of the second pretreatment composition, and/or the oxidizing agent is present in the second pretreatment composition in an amount of 50 ppm to 13,000 ppm based on total weight of the second pretreatment composition.

Aspect 10. The system of any of the preceding Aspects, wherein the second composition comprises a pH of 2 to 6.5.

Aspect 11. The system of any of the preceding Aspects, wherein the lanthanide series metal is present in the third pretreatment composition in an amount of 5 ppm to 25,000 ppm based on total weight of the third pretreatment composition.

Aspect 12. The system of any of the preceding Aspects, wherein the oxidizing agent is present in the third composition in an amount of 25 ppm to 13,000 ppm based on total weight of the third pretreatment composition.

Aspect 13. The system of any of the preceding Aspects, wherein the third pretreatment composition comprises a pH of 2 to 5.5.

Aspect 14. The system of any of the preceding Aspects, wherein the third pretreatment composition is substantially free, essentially free, or completely free of gelatin, lanthanide oxide, and/or copper.

Aspect 15. The system of any of the preceding Aspects, wherein the first pretreatment composition, second pretreatment composition, and/or third pretreatment composition is substantially free, essentially free, or completely free of phosphate.

Aspect 16. The system of any of the preceding Aspects, wherein the first pretreatment composition, second pretreatment composition, and/or third pretreatment composition is substantially free, essentially free, or completely free of chromium.

Aspect 17. The system of any of the preceding Aspects, further comprising a cleaner composition.

Aspect 18. The system of Aspect 17, wherein the cleaner composition comprises an alkaline pH.

Aspect 19. The system of Aspect 17, wherein the cleaner composition comprises an acidic pH.

Aspect 20. The system of any of the preceding Aspects, further comprising a film-forming composition.

Aspect 21. The system of Aspect 20, wherein the film-forming composition comprises an anionic electrodepositable coating composition, a cationic electrodepositable coating composition, a powder coating composition, a liquid coating composition, a primer composition, and/or a topcoat composition.

Aspect 22. A method of treating a metal substrate comprising: contacting at least a portion of a substrate surface with a first pretreatment composition comprising a fluorometallic acid comprising a Group IVA metal and/or a Group IVB metal and free fluoride in an amount of 10 ppm to 500 ppm based on total weight of the first pretreatment composition and having a pH of 1.0 to 4.0.

Aspect 23. The method of Aspect 22, wherein the fluorometallic acid comprises hexafluorosilicic acid, hexafluorozirconic acid, hexafluorotitanic acid, hexafluoroferric acid, hexafluoroaluminic acid, or combinations thereof.

Aspect 24. The method of Aspect 22 or Aspect 23, wherein the Group IVA metal is present in the first pretreatment composition in an amount of 10 ppm to 1,500 ppm based on total weight of the first pretreatment composition and/or wherein the Group IVB metal is present in the first pretreatment composition in an amount of 200 ppm to 5,000 ppm based on total weight of the first pretreatment composition.

Aspect 25. The method of any of Aspects 22 to 24, wherein the free fluoride derives from the fluorometallic acid and/or wherein the first pretreatment composition further comprises a fluoride source in addition to the fluorometallic acid and/or a hydroxide source.

Aspect 26. The method of any of Aspects 22 to 25, further comprising contacting at least a portion of the substrate surface with a second pretreatment composition comprising a Group IVB metal and free fluoride in an amount of 15 ppm to 200 ppm based on total weight of the second pretreatment composition or a third pretreatment composition comprising a lanthanide series metal and an oxidizing agent.

Aspect 27. The method of Aspect 26, wherein the Group IVB metal is present in the second pretreatment composition in an amount of 20 ppm to 1,000 ppm based on total weight of the second pretreatment composition.

Aspect 28. The method of Aspect 26 or Aspect 27, wherein the second pretreatment composition further comprises an electropositive metal, a Group IA metal, a Group VIB metal, a Group VIIIB metal, and/or an oxidizing agent.

Aspect 29. The method of Aspect 28, wherein the electropositive metal is present in the second pretreatment composition in an amount of 2 ppm to 100 ppm based on total weight of the second pretreatment composition, the Group IA metal is present in the second pretreatment composition in an amount of 2 ppm to 500 ppm based on total weight of the second pretreatment composition, the Group VIB metal is present in the second pretreatment composition in an amount of 5 ppm to 500 ppm based on total weight of the second pretreatment composition, the Group VIIIB metal is present in the second pretreatment composition in an amount of 0.1 ppm to 50 ppm based on total weight of the second pretreatment composition, and/or the oxidizing agent is present in the second pretreatment composition in an amount of 50 ppm to 13,000 ppm based on total weight of the second pretreatment composition.

Aspect 30. The method of any of Aspects 26 to 29, wherein the second composition comprises a pH of 2 to 6.5.

Aspect 31. The method of Aspect 26, wherein the lanthanide series metal is present in the third pretreatment composition in an amount of 5 ppm to 25,000 ppm based on total weight of the third pretreatment composition.

Aspect 32. The method of Aspect 26 or Aspect 31, wherein the oxidizing agent is present in the third composition in an amount of 25 ppm to 13,000 ppm based on total weight of the third pretreatment composition.

Aspect 33. The method of Aspect 26 or Aspect 31 or Aspect 32, wherein the third pretreatment composition comprises a pH of 2 to 5.5.

Aspect 34. The method of any of Aspect 26 or Aspects 31 to 33, wherein the third pretreatment composition is substantially free, essentially free, or completely free of gelatin, lanthanide oxide, and/or copper.

Aspect 35. The method of any of Aspects 22 to 34, wherein the first pretreatment composition, second pretreatment composition, and/or third pretreatment composition is substantially free, essentially free, or completely free of phosphate.

Aspect 36. The method of any of Aspects 22 to 35, wherein the first pretreatment composition, second pretreatment composition, and/or third pretreatment composition is substantially free, essentially free, or completely free of chromium.

Aspect 37. The method of any of Aspects 22 to 36, further comprising contacting at least a portion of the substrate surface with a cleaner composition.

Aspect 38. The method of any of Aspects 22 to 37, further comprising contacting at least a portion of the substrate surface with a film-forming resin.

Aspect 39. The method of Aspect 38, wherein the film-forming resin comprises an anionic electrodepositable coating composition, a cationic electrodepositable coating composition, a powder coating composition, a liquid coating composition, a primer composition, and/or a topcoat composition.

Aspect 40. The method of an of Aspects 22 to 39, wherein the substrate comprises magnesium or a magnesium alloy.

Aspect 41. A magnesium or magnesium alloy substrate comprising: a bilayer comprising a first layer comprising silicon in an amount of 1 atomic % to 10 atomic % from an air/substrate interface to at least 500 nm below the air/substrate interface and a second layer comprising fluoride in an amount of 1 atomic % to 50 atomic % from the air/substrate interface to at least 400 nm below the air/substrate interface as measured by XPS depth profiling using a Physical Electronics VersaProbe II instrument equipped with a monochromatic Al ka x-ray source (hv=1,486.7 eV and a concentric hemispherical analyzer.

Aspect 42. The substrate of Aspect 41, wherein the substrate, when exposed to exposed to Cycle B corrosion testing for at least 9 cycles, has an average scribe creep of less than 1.7 mm per cycle.

Aspect 43. The substrate of Aspect 41, wherein the substrate, when exposed to B117 salt spray testing for at least 7 days, has an average scribe creep of less than 2.5 mm per day.

Aspect 44. A treated substrate comprising a surface, wherein at least a portion of the surface is treated with the system of any of Aspects 1-21 or the method of any of Aspects 22-40.

Aspect 45. The substrate of Aspect 44, comprising a layer on at least a portion of the surface, wherein the layer is formed from one of the first, second, or third pretreatment compositions.

Aspect 46. The substrate of Aspect 44 or Aspect 45, wherein:
(a) the substrate, when exposed to Cycle B or B117 Salt Spray, has the scribe creep (per cycle, mm) that is decreased by at least 5% compared to scribe creep (per cycle, mm) of a substrate treated with the second pretreatment or the third pretreatment composition but not the first pretreatment composition;
(b) wherein the substrate, when exposed to Cycle B corrosion testing for at least 9 cycles, has an average scribe creep of less than 1.7 mm per cycle;
(c) wherein the substrate, when exposed to B117 salt spray testing for at least 7 days, has an average scribe creep of less than 2.5 mm per day; and/or
(d) the substrate comprises a bilayer comprising a first layer comprising silicon in an amount of 1 atomic % to 10 atomic % from an air/substrate interface to at least 500 nm below the air/substrate interface and a second layer comprising fluoride in an amount of 1 atomic % to 50 atomic % from the air/substrate interface to at least 400 nm below the air/substrate interface as measured by XPS depth profiling using a Physical Electronics VersaProbe II instrument equipped with a monochromatic Al ka x-ray source (hv=1,486.7 eV and a concentric hemispherical analyzer.

Aspect 47. The substrate of any of Aspects 41 to 46, wherein the substrate comprises a vehicle, a part, an article, a heat exchanger, an appliance, a personal electronic device, a multi-metal article, or combinations thereof.

Aspect 48. The substrate of Aspect 47, wherein the vehicle comprises an automobile or an aircraft.

Aspect 49. The substrate of any of Aspects 41 to 48, wherein the substrate comprises a three-dimensional component formed by an additive manufacturing process.

Aspect 50. The substrate of Aspect 49, wherein the additive manufacturing process comprises selective laser melting, e-beam melting, directed energy deposition, metal extrusion, and/or binder jetting.

Illustrating the invention are the following examples, which, however, are not to be considered as limiting the invention to their details. Unless otherwise indicated, all parts and percentages in the following examples, as well as throughout the specification, are by weight.

### EXAMPLES

### Preparation of Compositions Used in Examples 1-8

Preparation of Alkaline Cleaner I: A rectangular stainless-steel tank with a total volume of 37 gallons, equipped with spray nozzles, was filled with 10 gallons of deionized water. To this was added 500 mL of Chemkleen 2010LP (a phosphate-free alkaline cleaner available from PPG Industries, Inc.) and 50 mL of Chemkleen 181ALP (a phosphate-free blended surfactant additive available from PPG Industries, Inc.).

A 10 mL sample of the Alkaline Cleaner I was titrated with 0.100 N sulfuric acid to measure the free and total alkalinity. The free alkalinity was 5.2 mL as measured using a phenolphthalein end point (pink to colorless color change) and the total alkalinity was 6.4 mL as measured to a bromocresol green end point (blue to yellow color change). Alkaline Cleaner I was used in Examples 1, 2, 3, and 4 as described below.

Preparation of First Pretreatment Compositions: Seven different pretreatment compositions (Pretreatments 1-7) were prepared for testing. The compositions are listed in Table 2, below. Silicon was supplied by adding hydrofluorosilicic acid (23% in water), available from Thermofisher Acros Organics (Geel, Belgium); free fluoride was supplied by adding potassium bifluoride (99.3%), available from Sigma-Aldrich (St. Louis, MO); titanium was supplied by hexafluorotitanic acid (60% in water), available from Sigma-Aldrich; zirconium was supplied by adding fluorozirconic acid (45 wt. % in water) available from Honeywell International, Inc. (Morristown, NJ); concentrated sulfuric acid was purchased from Fisher Chemical (Pittsburgh, PA); AMC 257 (a neutral acid metal conditioner available from PPG Industries (Pittsburgh, PA)); sodium hexafluoroferrate (III) was purchased from Sigma-Aldrich; concentrated nitric acid was supplied by Fisher Chemical. The pH of each pretreatment composition was measured using a pH meter (interface, DualStar pH/ISE Dual Channel Benchtop Meter, available from ThermoFisher Scientific, Waltham, Massachusetts, USA; pH probe, Fisher Scientific Accumet pH probe (Ag/AgCl reference electrode) by immersing the pH probe in the pretreatment composition.

Pretreatment Composition Bath 1 (PT-1): To a clean three-gallon plastic bucket was added 11.25 liters of deionized water. Fluorosilicic acid (109 g), potassium bifluoride (7 g) and sodium hydroxide (9.5 g) were then added.

Pretreatment Composition Bath 2 (PT-2): To a clean three-gallon plastic bucket was added 11.25 liters of deionized water. Sulfuric acid (48 g) and hexafluorozirconic acid (4.8 g) were then added.

Pretreatment Composition Bath 3 (PT-3): To a clean three-gallon plastic bucket was added 11.25 liters of deionized water. Fluorosilicic acid (109 g) was then added.

Pretreatment Composition Bath 4 (PT-4): Pretreatment 4 was prepared with 5% v/v concentration of AMC257 (a weakly acidic deoxidizer free of nitric acid available from PPG) in a clean three-gallon plastic bucket.

Pretreatment Composition Bath 5 (PT-5): To a clean three-gallon plastic bucket was added 11.25 liters of deionized water. Hexafluorotitanic acid (47.6 g), potassium bifluoride (7 g) and sodium hydroxide (9.5 g) were then added.

Pretreatment Composition Bath 6 (PT-6): To a clean three-gallon plastic bucket was added 11.25 liters of deionized water. Hexafluorozirconic acid (80 g), potassium bifluoride (7 g) and sodium hydroxide (9.5 g) were then added.

Pretreatment Composition Bath 7 (PT-7): To a clean three-gallon plastic bucket was added 11.25 liters of deionized water. Sodium hexafluoroferrate (III) (27 g), potassium bifluoride (7 g) and sodium hydroxide (9.5 g) were then added. Concentrated nitric acid (Approx. 5 mL) was added to adjust the pH to 2.7.

TABLE 2
First Pretreatment Compositions.

| First | | | Free | | Metal |
|---|---|---|---|---|---|
| Pretreatment | Acid | | fluoride | | Concentration |
| Composition | Component | pH | (ppm) | Additive | ppm |
| PT-1 | H₂SiF₆ | 2.5 | 64 | — | 1290 |
| PT-2 | H₂SO₄, | 1.5 | 0.93 | — | 250 |
| | H₂ZrF₆ | | | | |
| PT-3 | H₂SiF₆ | 2.5 | 3.8 | — | 1290 |
| PT-4 | Citric acid | 5.2 | 0 | — | N/A |
| PT-5 | H₂TiF₆ | 2.3 | 16 | — | 2200 |
| PT-6 | H₂ZrF₆ | 2.4 | 59 | — | 4190 |
| PT-7 | HNO₃ | 2.7 | 160 | Na₃FeF₆ | 6310 |

Preparation of Second Pretreatment Compositions: Five different zirconium-containing pretreatment compositions (PT A-E) were prepared for testing. Each pretreatment bath was built by the addition of the metal-containing species listed in Table 3 below and described in more detail below. Zirconium was supplied to the pretreatment baths by adding fluorozirconic acid (45 wt. % in water) available from Honeywell International, Inc. (Morristown, NJ); copper was supplied by adding a 2 wt. % Cu solution, which was prepared by dilution of a copper nitrate solution (18 wt. % Cu in water) available from Shepherd Chemical Company (Cincinnati, OH); molybdenum was supplied by adding sodium molybdate dihydrate available from Thermofisher Acros Organics (Geel, Belgium); phosphoric acid (85%) was supplied by Fisher Chemical (Pittsburgh, PA); and iron was supplied by adding iron (III) sulfate hydrate available from Alfa Aesar (Tewksbury, MA).

After all of the ingredients were added to the pretreatment bath, pH was measured using a pH meter (interface, DualStar pH/ISE Dual Channel Benchtop Meter, available from ThermoFisher Scientific, Waltham, Massachusetts, USA; pH probe, Fisher Scientific Accumet pH probe (Ag/AgCl reference electrode) by immersing the pH probe in the pretreatment solution. Free fluoride was measured using a DualStar pH/ISE Dual Channel Benchtop Meter (ThermoFisher Scientific) equipped with a fluoride selective electrode (Orion ISE Fluoride Electrode, solid state, available from ThermoFisher Scientific) by immersing the ISE in the pretreatment solution and allowing the measurement to equilibrate. Then, the pH was adjusted as needed to a pH range of 4.6 to 4.8 with Chemfil buffer (an alkaline buffering solution, commercially available from PPG Industries, Inc.) or fluorozirconic acid (45 wt. % in water, available from Honeywell International, Inc., Morristown, NJ). The free fluoride was adjusted as needed to a range of 75 to 90 ppm with Chemfos AFL (a partially neutralized aqueous ammonium bifluoride solution, commercially available from PPG Industries, Inc. and prepared according to supplier instructions). The amount of copper in each Bath was measured using a DR/890 Colorimeter (available from HACH, Loveland, Colorado, USA) using an indicator (CuVer1 Copper Reagent Powder Pillows, available from HACH).

In the following Examples, any bath that was heated above ambient temperature was heated with an immersion heater (Polyscience Sous Vide Professional, Model #7306AC1B5, available from Polyscience, Niles, Illinois). Baths containing the second pretreatment were set to low agitation mode during immersion of panels, to circulate and heat the composition contained therein; baths containing the first pretreatment composition were set to high agitation mode.

Pretreatment Composition Bath A (PT-A): To a clean three-gallon plastic bucket was added 11.37 liters of deionized water. Fluorozirconic acid (11.5 g) was then added. The material was circulated using an immersion heater set to 80° F. and high agitation. The pH and free fluoride were measured as described above and pH and free fluoride were adjusted with 20 g Chemfil buffer and 7 g Chemfos AFL.

Pretreatment Composition Bath B (PT-B): To a clean three-gallon plastic bucket was added 11.37 liters of deionized water. Fluorozirconic acid (11 g) was then added, along with a 2% copper solution (12 g), iron (III) sulfate hydrate (0.6 g), and phosphoric acid (0.2 g). The material was circulated using the immersion heater described above, set to 80° F. and high agitation. The pH and free fluoride were measured as described above and pH and free fluoride were adjusted with 22 g Chemfil buffer and 5 g Chemfos AFL.

Pretreatment Composition Bath C (PT-C): To a clean three-gallon plastic bucket was added 11.37 liters of deionized water. Fluorozirconic acid (11 g) was then added, along with a 2% copper solution (12 g), iron (III) sulfate hydrate (0.09 g), and phosphoric acid (0.2 g). The material was circulated using the immersion heater described above, set to 80° F. and high agitation. The pH and free fluoride were measured as described above and pH and free fluoride were adjusted with 22 g Chemfil buffer and 2 g Chemfos AFL.

Pretreatment Composition Bath D (PT-D): To a clean three-gallon plastic bucket was added 11.37 liters of deionized water. Fluorozirconic acid (11.5 g) and 21 grams of a 2% copper solution were then added. The material was circulated using the immersion heater described above, set to 80° F. and high agitation. The copper, pH and free fluoride were measured as described above and pH and free fluoride were adjusted with 19 g Chemfil buffer and 7 g Chemfos AFL.

Pretreatment Composition Bath E (PT-E): To a clean five-gallon plastic bucket was added 11.37 liters of deionized water. Fluorozirconic acid (10 g) and 12 grams of a 2% copper solution were then added followed by sodium molybdate dihydrate (1.15 g) and lithium nitrate (1.16 g). The material was circulated using the immersion heater described above, set to 80° F. and high agitation. The copper, pH and free fluoride were measured as described above and pH and free fluoride were adjusted with 18 g Chemfil buffer and 7 g Chemfos AFL.

TABLE 3
Second Pretreatment Compositions.

| Second | | | | | | | Free |
|---|---|---|---|---|---|---|---|
| Pretreatment | Zr | Fe | Mo | Li | Cu | | fluoride |
| Composition | (ppm) | (ppm) | (ppm) | (ppm) | (ppm) | pH | (ppm) |
| PT-A | 195 | 0 | 0 | 0 | 0 | 4.6 | 90 |
| PT-B | 186 | 4.9 | 0 | 0 | 20 | 4.5 | 75 |
| PT-C | 186 | 0.74 | 0 | 0 | 20 | 5.0 | 75 |
| PT-D | 195 | 0 | 0 | 0 | 35 | 4.6 | 90 |
| PT-E | 170 | 0 | 45 | 5 | 20 | 4.8 | 90 |

Preparation of Third Pretreatment Compositions: A cerium-containing pretreatment compositions (PT-F) was prepared for testing. The pretreatment bath was built by the addition of the metal-containing species listed in Table 4 below and described in more detail below.

Pretreatment Composition Bath F (PT-F): To a clean one-gallon plastic bucket was added 3.78 liters of deionized water. Cerium chloride heptahydate (Sigma) (24 g) and 10.1 grams of a 30% hydrogen peroxide solution were then added. When the solution turned orange, it was transferred to a 1-gallon sleeve for use as pretreatment. The bath remained at ambient temperature, and agitation was provided by manually moving the panel holders while submerged in the bath.

TABLE 4
Third Pretreatment Composition.

| Third | | | | | | | | Free |
|---|---|---|---|---|---|---|---|---|
| Pretreatment | Zr | Fe | Mo | Li | Cu | Ce | | fluoride |
| Composition | (ppm) | (ppm) | (ppm) | (ppm) | (ppm) | (ppm) | pH | (ppm) |
| PT-F | 0 | 0 | 0 | 0 | 0 | 3580 | 3.5 | 0 |

For Examples 1-7, ZEK100 magnesium substrate provided by USAMP from POSCO (Pohang, SK) was evaluated. POSCO ZEK100 magnesium panels were cut from 24″ by 40″ to 4″ by 5″ (or 4″ by 6″) using a panel cutter prior to application of the alkaline cleaner. For Examples 7 and 8, Eform Plus magnesium substrate provided by USAMP from POSCO was also evaluated. POSCO Eform Plus magnesium panels were cut from 21.7″ by 24″ to 4″ by 6″ using a panel cutter prior to application of the alkaline cleaner.

Panels were treated using either Treatment Method A or B, outlined in Tables 5 and 6 below. For panels treated according to Treatment Method A, panels were spray cleaned and degreased for 120 seconds at 10-15 psi in the alkaline cleaner (125° F.) using Vee-jet nozzles and rinsed with deionized water by immersing in a deionized water bath (75° F.) for 30 seconds followed by a deionized water spray rinse using a Melnor Rear-Trigger 7-Pattern nozzle set to shower mode (available from Home Depot). All panels were immersed in either PT-A, PT-B, PT-C, PT-D, or PT-E for 120 seconds (80° F.), rinsed by a deionized water spray rinse using the using a Melnor Rear-Trigger 7-Pattern nozzle set to shower mode (75° F.) for 30 seconds, and dried with hot air (140° F.) for 120 seconds using a Hi-Velocity handheld blow-dryer made by Oster® (model number 078302-300-000) on high-setting.

For panels treated according to Treatment Method B, panels were cleaned, pretreated, and rinsed as in Method A, except that following the alkaline cleaning step and subsequent rinses, wet panels were immersed in one of the First Pretreatment Compositions (PT 1-7) for 120 seconds (80° F.), followed by a deionized water spray rinse using the Melnor Rear-Trigger 7-Pattern nozzle set to shower mode (75° F.) for 30 seconds and then were dried with hot air (140° F.) for 120 seconds using a Hi-Velocity handheld blow-dryer made by Oster® (model number 078302-300-000) on high-setting. SC-1 and SC-2 were sprayed onto the pretreated panel using the identical tanks to those used in the cleaning stage (stainless steel, 37-gallon capacity).

TABLE 5
Treatment Method A.

| | |
|---|---|
| Step 1A | Alkaline cleaner (120 seconds, |
| | 120° F., spray application) |
| Step 2A | Deionized water rinse (30 seconds, |
| | 75° F., immersion application) |
| Step 3A | Deionized water rinse (30 seconds, |
| | 75° F., spray application) |
| Step 4A | Second Pretreatment Composition (120 seconds, |
| | 80° F., immersion application) |
| | or Third Pretreatment Composition |
| | (120 seconds, ambient, immersion application) |
| Step 5A | Deionized water rinse (30 seconds, |
| | 75° F., spray application) |
| Step 6A | Hot Air Dry (120 seconds, 140° F.) |

TABLE 6
Treatment Method B.

| | |
|---|---|
| Step 1B | Alkaline cleaner (120 seconds, |
| | 125° F., spray application) |
| Step 2B | Deionized water rinse (30 seconds, |
| | 75° F., immersion application) |
| Step 3B | Deionized water rinse (30 seconds, |
| | 75° F., spray application) |
| Step 4B | First Pretreatment Composition (120 seconds, |
| | 80° F., immersion application) |
| Step 5B | Deionized water rinse (30 seconds, |
| | 75° F., spray application) |
| Step 6B | Second Pretreatment Composition (120 seconds, |
| | 80° F., immersion application) |
| | or Third Pretreatment Composition (120 seconds, |
| | ambient, immersion application) |
| Step 7B | Deionized water rinse (30 seconds, |
| | 75° F., spray application) |
| Step 8B | Hot Air Dry (120 seconds, 140° F.) |

In Examples 1-6, following completion of Treatment Methods A or B, all panels were electrocoated with ED7000Z (a cationic electrocoat with components commercially available from PPG). In Examples 7-10, all panels were electrocoated with EPIC 200 Hermosillo, (a cationic electrocoat with components commercially available from PPG). In Examples 11-12, all panels were treated with EPIC 200 FRAP (a cationic electrocoat with components commercially available from PPG). In all cases, the electrocoat paint was ultrafiltered removing 25% of the material, which was replenished with fresh deionized water. The rectifier (Xantrax Model XFR600-2, Elkhart, Indiana, or Sorensen XG 300-5.6, Ameteck, Berwyn, Pennsylvania) was DC power supplied. The electrocoat application conditions were voltage set point of 180V-200V, a ramp time of 30 s, and a current density of 1.6 mA/cm2. The electrocoat was maintained at 90° F. The film thickness was coulomb controlled to deposit a target film thickness of 0.6±0.2 mils for ED7000Z and 0.75±0.2 mils for EPIC. The DFT was controlled by changing the amount of charge (coulombs) that passed through the panels. Following deposition of the electrocoat, panels were baked in an oven (Despatch Model LFD-1-42) at 177° C. for 25 minutes.

Electrocoated panels were scribed with a 10.2 cm vertical line in the middle of the panel down to the metal substrate. Scribed panels were exposed to GM cyclic corrosion test GMW14872 for a minimum of nine days up to 40 days. X-scribed panels were exposed to ASTM B117 salt spray for a minimum of one week up to 40 days. Panels for each condition were run in duplicate. The average scribe creep of two panels for each treatment combination are listed in Tables 7-20 below. Scribe creep refers to the area of paint loss around the scribe either through corrosion or disbondment (e.g.: affected paint to affected paint). A scribe creep listed as “Fail” indicates catastrophic delamination of the electrocoat layer that precludes reliable scribe creep measurements.

### Example 1

### Corrosion Performance on ZEK100 Panels Treated According to Treatment Method A

ZEK100 magnesium panels were treated according to Treatment Method A (Table 5). Panels were then electrocoated with ED7000Z according to the parameters described above. Panels were scribed and subjected to either cyclic corrosion testing or continuous salt spray corrosion testing as specified in Table 7.

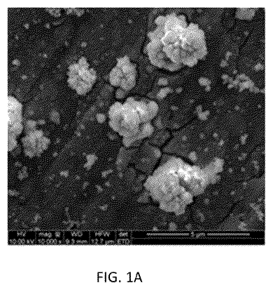

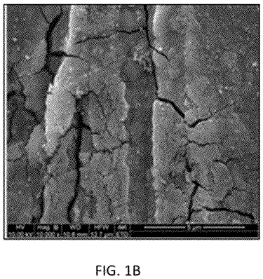

SEM imaging is shown in FIG. 1A. The panel was prepared for top/down FESEM imaging by cutting a small section using the panel cutter and placing it on top of carbon tape attached to an SEM stub. The sample was then sputter coated with a thin film of Au/Pd. Analysis was performed on the Quanta 250 FESEM operating at 10 kV in high vacuum mode using the ETD detector to show surface details. FIG. 1A demonstrates nodules of zirconium present on the substrate surface following treatment of the panel as described above.

XPS depth profiling data are reported in FIG. 2A. The XPS depth profile of the substrates were generated using a Physical Electronics VersaProbe II instrument equipped with a monochromatic Al ka x-ray source (hv=1,486.7 eV) and a concentric hemispherical analyzer. Charge neutralization was performed using both low energy electrons (<5 eV) and argon ions. The binding energy axis was calibrated using sputter cleaned Cu foil (Cu 2p3/2=932.62 eV, Cu 2p3/2=75.1 eV) and Au foils (Au 4f7/2=83.96 eV). Peaks were charge referenced to CHx band in the carbon is spectra at 284.8 eV. Measurements were made at a takeoff angle of 450 with respect to the sample surface plane. This resulted in a typical sampling depth of 3-6 nm (95% of the signal originated from this depth or shallower). Quantification was done using instrumental relative sensitivity factors (RSFs) that account for the x-ray cross section and inelastic mean free path of the electrons. Ion sputtering was done using 2 kV Ar+ rastered over a 2 mm×2 mm area. The sputtering rate in the Al2O3 layer was 9.5 nm/min. As discussed above, FIG. 2A demonstrates the absence of the silicon-fluoride bilayer on a magnesium alloy substrate treated only with an alkaline cleaner and a zirconium-containing pretreatment composition.

TABLE 7
Scribe Creep results for Example 1.

| | Cycle B | Scribe | B117 Salt | B117 Salt |
|---|---|---|---|---|
| | scribe | creep | Spray | Spray |
| | creep (9 | per | scribe | scribe |
| Pretreatment | cycles, | cycle | creep | creep |
| Code | mm) | (mm) | (7 days) | per day |
| None | 15.4 | 1.71 | Fail | N/A |
| (clean only) | | | | |
| PT-A | 4.40 | 0.489 | Fail | N/A |
| PT-B | 5.37 | 0.596 | Fail | N/A |
| PT-C | 3.47 | 0.385 | Fail | N/A |
| PT-D | 4.77 | 0.531 | Fail | N/A |
| PT-E | 3.66 | 0.406 | Fail | N/A |
| PT-F | 14.92 | 1.66 | Fail | N/A |

### Example 2

### Corrosion Performance on ZEK100 Panels Treated With PT-1 According to Treatment Method B

ZEK100 magnesium panels were treated according to Treatment Method B (Table 6). Panels were then electrocoated with ED7000Z according to the parameters described above. Panels were scribed and subjected to either cyclic corrosion testing or continuous salt spray corrosion testing as specified in Table 8.

SEM imaging was performed as described in Example 1 and is shown in FIG. 1B. FIG. 1B demonstrates a more continuous distribution of zirconium on the substrate surface when the panel was immersed in PT-1 followed by PT-D.

XPS depth profiling was measured as described in Example 1 and data are reported in FIG. 2B and FIGS. 3A-3D. As shown in FIG. 2B and as discussed above, treatment of the ZEK100 magnesium panel with PT-1 resulted in the formation of a silicon/fluoride bilayer. FIGS. 3A-3D depict the change in atomic percent of magnesium, oxygen, fluoride, and silicon as a function of immersion time in PT-1 as measured by XPS. The profiling depth increases from the pale grey curves to the black curves up to a depth of 632 nm. Elemental magnesium (FIG. 3A) increases with depth profiling and remains steady after an initial decrease over time. Oxygen (FIG. 3B) levels increase, then decrease, with depth profiling and saturate at a lower level after 60 seconds of immersion time. Fluoride (FIG. 3C) content increases with immersion time and saturates between 120 seconds to 180 seconds. Silicon (FIG. 3D) content saturates rapidly (15 seconds to 30 seconds) and remains most concentrated at shallow profiling depths.

Transmission electron microscopy (TEM) was used to analyze one panel in Example 2. Specifically, FIB-EDS-TEM of a ZEK100 magnesium substrate treated according to Example 2 (PT-1, followed by PT-D) was analyzed using one panel. To prepare a cross-section of the panel for TEM analysis, a protective layer of carbon and a protective layer of gold were deposited on the sample before the focused ion beam (FIB) preparation. The focused ion beam (FIB) lift-out method was used via a FEI Helios NanoLab 660. High-angle annular dark-field scanning transmission electron microscopy (HAADF STEM) and energy dispersive x-ray spectroscopy (EDX) analysis was performed at Penn State University's Materials Research Institute on the FEI Talos TEM (200 kV). FIG. 4A shows a high-angle annular diffraction TEM micrograph. FIGS. 4B-4F are TEM micrographs overlaid with elemental maps (4B, zirconium; 4C, magnesium; 4D, fluoride; 4E, silicon; 4F, oxygen) as determined by EDS. A bilayer structure is formed within the oxide layer, with a dense layer of fluoride below a silicon-enriched layer, which provides corrosion protection. The zirconium deposited from the second pretreatment forms a uniform, continuous layer on top which does not disrupt the bilayer structure below it.

TABLE 8
Scribe Creep results for Example 2.

| | Cycle B | | B117 Salt | B117 Salt |
|---|---|---|---|---|
| | scribe | Scribe | Spray | Spray |
| | creep (15 | creep per | scribe | scribe |
| Pretreatment | cycles, | cycle | creep | creep |
| Code | mm) | (mm) | (7 days) | per day |
| None | 7.53 | 0.502 | 6.46 | 0.92 |
| (clean only) | | | | |
| PT-A | 5.79 | 0.386 | 3.08 | 0.44 |
| PT-B | 3.30 | 0.220 | 3.73 | 0.53 |
| PT-C | 6.33 | 0.422 | 6.07 | 0.87 |
| PT-D | 6.30 | 0.420 | 4.48 | 0.64 |
| PT-E | 5.56 | 0.370 | 4.42 | 0.63 |
| PT-F | 3.71 | 0.247 | 4.96 | 0.71 |

### Example 3

### Corrosion Performance on ZEK100 Panels Treated With PT-2 According to Treatment Method B

ZEK100 magnesium panels were treated according to Treatment Method B (Table 6). Panels were then electrocoated with ED7000Z according to the parameters described above. Panels were scribed and subjected to either cyclic corrosion testing or continuous salt spray corrosion testing as specified in Table 9.

TABLE 9
Scribe Creep results for Example 3.

| | Cycle B | | B117 | B117 |
|---|---|---|---|---|
| | scribe | Scribe | scribe | scribe |
| | creep (11 | creep per | creep | creep per |
| Pretreatment | cycles, | cycle | (7 days, | day |
| Code | mm) | (mm) | mm) | (mm) |
| None (clean | 11.9 | 1.08 | 17.03 | 2.43 |
| only) | | | | |
| PT-A | 8.34 | 0.758 | 16.10 | 2.30 |
| PT-B | 12.3 | 1.11 | 20.03 | 2.86 |
| PT-C | 8.39 | 0.763 | 17.28 | 2.47 |
| PT-D | 10.9 | 0.987 | 19.72 | 2.82 |
| PT-E | 10.2 | 0.925 | 17.10 | 2.44 |

### Example 4

### Corrosion Performance on ZEK100 Panels Treated With PT-3 According to Treatment Method B

ZEK100 magnesium panels were treated according to Treatment Method B (Table 6). Panels were then electrocoated with ED7000Z according to the parameters described above. Panels were scribed and subjected to either cyclic corrosion testing or continuous salt spray corrosion testing as specified in Table 10.

TABLE 10
Scribe Creep results for Example 4.

| | | | B117 Salt | B117 Salt |
|---|---|---|---|---|
| Pre- | Cycle B scribe | Scribe creep | Spray scribe | Spray scribe |
| treatment | creep (10 | per cycle | creep (7 | creep per |
| Code | cycles, mm) | (mm) | days) | day |
| None (clean | 7.91 | 0.791 | Fail | N/A |
| only) | | | | |
| PT-A | 2.00 | 0.200 | Fail | N/A |
| PT-B | 2.51 | 0.251 | Fail | N/A |
| PT-C | 2.86 | 0.286 | Fail | N/A |
| PT-D | 2.69 | 0.269 | 3.7 | 0.53 |
| PT-E | 2.61 | 0.261 | 5.1 | 0.73 |

### Example 5

### Corrosion Performance on ZEK100 Panels Treated With PT-4 According to Treatment Method B

ZEK100 magnesium panels were treated according to Treatment Method B (Table 6). Panels were then electrocoated with ED7000Z according to the parameters described above. Panels were scribed and subjected to either cyclic corrosion testing or continuous salt spray corrosion testing as specified in Table 11.

TABLE 11
Scribe Creep results for Example 5.

| | | | B117 Salt | B117 Salt |
|---|---|---|---|---|
| Pre- | Cycle B scribe | Scribe creep | Spray scribe | Spray scribe |
| treatment | creep (11 | per cycle | creep (7 | creep per |
| Code | cycles, mm) | (mm) | days) | day |
| None (clean | 21.35 | 1.94 | Fail | N/A |
| only) | | | | |
| PT-A | 14.38 | 1.31 | Fail | N/A |
| PT-B | 12.13 | 1.10 | Fail | N/A |
| PT-C | 9.52 | 0.865 | Fail | N/A |
| PT-D | 10.31 | 0.937 | 25.0 | 3.57 |
| PT-E | 4.97 | 0.452 | 19.4 | 2.77 |

### Example 6

### Corrosion Performance on ZEK100 Panels Treated With PT-5 According to Treatment Method B

ZEK100 magnesium panels were treated according to Treatment Method B (Table 6). Panels were then electrocoated with ED7000Z according to the parameters described above. Panels were scribed and subjected to either cyclic corrosion testing or continuous salt spray corrosion testing as specified in Table 12.

TABLE 12
Scribe Creep results for Example 6.

| | | | B117 Salt | B117 Salt |
|---|---|---|---|---|
| | Cycle B scribe | Scribe creep | Spray scribe | Spray scribe |
| Pretreatment | creep (15 | per cycle | creep (12 | creep per |
| Code | cycles, mm) | (mm) | days) | day |
| None (clean | 15.24 | 1.00 | 15.47 | 1.29 |
| only) | | | | |
| PT-A | 2.47 | 0.146 | 2.92 | 0.26 |
| PT-B | 2.19 | 0.171 | 3.31 | 0.28 |
| PT-C | 3.57 | 0.23 | 3.71 | 0.31 |
| PT-D | 2.55 | 0.167 | 4.22 | 0.35 |
| PT-E | 2.74 | 0.178 | 3.56 | 0.30 |

### Example 7

### Corrosion Performance on ZEK100 Panels Treated With PT-6 and PT-D According to Treatment Method B

ZEK100 magnesium panels were treated according to Treatment Method B (Table 6). Panels were then electrocoated with ED7000Z according to the parameters described above. Panels were scribed and subjected to either cyclic corrosion testing or continuous salt spray corrosion testing as specified in Table 13.

TABLE 13
Scribe Creep results for Example 7.

| | Cycle B scribe | Scribe creep | | B117 Salt Spray | B117 Salt |
|---|---|---|---|---|---|
| | creep (20 | per cycle | Days in B117 | scribe creep | Spray scribe |
| Panel | cycles, mm) | (mm) | Salt Spray | (mm) | creep per day |
| 1 | 0.95 | 0.048 | — | — | — |
| 2 | 0.84 | 0.042 | — | — | — |
| 3 | — | — | 33 | 3.97 | 0.12 |
| 4 | — | — | 37 | 4.56 | 0.12 |

### Example 8

### Corrosion Performance on ZEK100 Panels Treated With Alkaline Cleaner, PT-7, and PT-D According to Treatment Method B

TABLE 14
Scribe Creep results for Example 8.

| | Cycle B scribe | Scribe creep | | B117 Salt Spray | B117 Salt |
|---|---|---|---|---|---|
| | creep (20 | per cycle | Days in B117 | scribe creep | Spray scribe |
| Panel | cycles, mm) | (mm) | Salt Spray | (mm) | creep per day |
| 1 | 3.46 | 0.17 | — | — | — |
| 2 | 4.47 | 0.22 | — | — | — |
| 3 | — | — | 8 | 6.19 | 0.77 |
| 4 | — | — | 11 | 8.05 | 0.73 |

### Example 9

### Corrosion Performance on Eform Plus Panels Treated With Alkaline Cleaner, PT-6, and PT-D According to Treatment Method B

TABLE 15
Scribe Creep results for Example 11.

| | Cycle B scribe | Scribe creep | | B117 Salt Spray | B117 Salt |
|---|---|---|---|---|---|
| | creep (20 | per cycle | Days in B117 | scribe creep | Spray scribe |
| Panel | cycles, mm) | (mm) | Salt Spray | (mm) | creep per day |
| 1 | 0.5 | 0.025 | — | — | — |
| 2 | 0.48 | 0.024 | — | — | — |
| 3 | — | — | 40 | 1.33 | 0.033 |
| 4 | — | — | 40 | 1.87 | 0.047 |

### Example 10

### Corrosion Performance on Eform Plus Panels Treated With Alkaline Cleaner, PT-7, and PT-D According to Treatment Method B

TABLE 16
Scribe Creep results for Example 12.

| | Cycle B scribe | Scribe creep | | B117 Salt Spray | B117 Salt |
|---|---|---|---|---|---|
| | creep (20 | per cycle | Days in B117 | scribe creep | Spray scribe |
| Panel | cycles, mm) | (mm) | Salt Spray | (mm) | creep per day |
| 1 | 0.75 | 0.038 | — | — | — |
| 2 | 0.52 | 0.026 | — | — | — |
| 3 | — | — | 40 | 1.88 | 0.047 |
| 4 | — | — | 40 | 1.36 | 0.034 |

### Example 11

### Corrosion Performance on Eform Plus Panels Treated According to Treatment Method A

TABLE 17
B117 Salt Spray Scribe Creep results for Example 11.

| | | B117 Salt | | B117 Salt Spray |
|---|---|---|---|---|
| Pretreatment | | Spray scribe | Days to | scribe creep per |
| Code | Replicate | creep (mm) | Failure | day (mm) |
| None (clean, | Panel 1 | 8.15 | 22 | 0.37 |
| only) | Panel 2 | 7.65 | 15 | 0.51 |
| PT-A | Panel 1 | 9.00 | 15 | 0.60 |
| | Panel 2 | 8.20 | 13 | 0.63 |
| PT-B | Panel 1 | 10.39 | 14 | 0.74 |
| | Panel 2 | 11.65 | 13 | 0.90 |
| PT-C | Panel 1 | 6.92 | 15 | 0.46 |
| | Panel 2 | 8.61 | 13 | 0.66 |
| PT-D | Panel 1 | 9.49 | 18 | 0.53 |
| | Panel 2 | 7.83 | 13 | 0.60 |
| PT-E | Panel 1 | 16.47 | 13 | 1.27 |
| | Panel 2 | 11.58 | 13 | 0.89 |

TABLE 18
Cycle B Scribe Creep results for Example 11.

| Pretreatment | Cycle B scribe creep | Scribe creep per |
|---|---|---|
| Code | (20 cycles, mm) | cycle (mm) |
| None (clean only) | 4.26 | 0.21 |
| PT-A | 11.77 | 0.59 |
| PT-B | 9.82 | 0.49 |
| PT-C | 7.97 | 0.40 |
| PT-D | 8.31 | 0.42 |
| PT-E | 17.53 | 0.88 |

### Example 12

### Corrosion Performance on Eform Plus Panels Treated With PT-1 According to Treatment Method B

One panel from Example 12 was analyzed using a transmission electron microscope (TEM) as described in Example 2. FIG. 5 shows FIB-EDS-TEM of an Eform Plus magnesium substrate treated according to Example 12 (PT-1 with no second pretreatment). FIG. 5A shows a high-angle annular diffraction TEM micrograph. FIGS. 5B-E show TEM micrographs overlaid with elemental maps as determined by EDS. A bilayer structure is formed within the oxide layer, with a dense layer of fluoride below a silicon-enriched layer, which provides corrosion protection.

TABLE 19
B117 Salt Spray Scribe Creep results for Example 12.

| | | B117 Salt | | B117 Salt Spray |
|---|---|---|---|---|
| Pretreatment | | Spray scribe | Days to | scribe creep per |
| Code | Replicate | creep (mm) | Failure | day (mm) |
| None (clean only) | Panel 1 | 10.22 | 43 | 0.24 |
| | Panel 2 | 5.94 | 54 | 0.11 |
| PT-A | Panel 1 | 10.03 | 32 | 0.31 |
| | Panel 2 | 7.80 | 15 | 0.52 |
| PT-B | Panel 1 | 8.30 | 22 | 0.38 |
| | Panel 2 | 7.22 | 43 | 0.17 |
| PT-C | Panel 1 | 6.28 | 48 | 0.13 |
| | Panel 2 | 7.76 | 54 | 0.14 |
| PT-D | Panel 1 | 7.60 | 32 | 0.23 |
| | Panel 2 | 10.58 | 19 | 0.56 |
| PT-E | Panel 1 | 11.10 | 25 | 0.44 |
| | Panel 2 | 13.73 | 25 | 0.55 |

TABLE 20
Cycle B Scribe Creep results for Example 12.

| Pretreatment | Cycle B scribe creep | Scribe creep per |
|---|---|---|
| Code | (20 cycles, mm) | cycle (mm) |
| None (clean only) | 6.29 | 0.31 |
| PT-A | 3.03 | 0.15 |
| PT-B | 4.19 | 0.14 |
| PT-C | 2.75 | 0.21 |
| PT-D | 3.54 | 0.18 |
| PT-E | 5.6 | 0.28 |

### Example 13

### Corrosion Performance on HDG Panels Treated According to Treatment Method A

HDG panels were treated according to Treatment Method A (Table 6). Panels were then electrocoated with EPIC 200 FRAP according to the parameters described above. Panels were scribed and subjected to cyclic corrosion testing as specified in Table 8.

TABLE 21
Scribe Creep results for Example 13.

| Pretreatment | Cycle B scribe creep | Scribe creep per |
|---|---|---|
| Code | (40 cycles, mm) | cycle (mm) |
| PT-D | 4.72 | 0.118 |

### Example 14

### Corrosion Performance on HDG Panels Treated According to Treatment Method B

HDG panels were treated according to Treatment Method B (Table 7). Panels were then electrocoated with EPIC 200 FRAP according to the parameters described above. Panels were scribed and subjected to cyclic corrosion testing as specified in Table 8.

TABLE 22
Scribe Creep results for Example 14.

| First | Second | Cycle B scribe | |
|---|---|---|---|
| Pretreatment | Pretreatment | creep (40 cycles, | Scribe creep per |
| Code | Code | mm) | cycle (mm) |
| PT-1 | None | 4.75 | 0.118 |
| PT-5 | None | 5.49 | 0.137 |
| PT-6 | None | 6.66 | 0.167 |
| PT-1 | PT-D | 6.35 | 0.159 |
| PT-5 | PT-D | 5.09 | 0.127 |
| PT-6 | PT-D | 4.35 | 0.109 |

### Example 15

### Corrosion Performance on AA6111 Panels Treated According to Treatment Method A

AA6111 panels were treated according to Treatment Method A (Table 6). Panels were then electrocoated with EPIC 200 FRAP according to the parameters described above. Panels were scribed and subjected to ASTM G-85 A2 testing as specified in Table 8.

TABLE 23
Scribe Creep results for Example 15.

| Pretreatment | G-85 A2 scribe creep | Scribe creep per |
|---|---|---|
| Code | (21 cycles, mm) | cycle (mm) |
| PT-D | 1.14 | 0.054 |

### Example 16

### Corrosion Performance on AA6111 Panels Treated According to Treatment Method B

AA6111 panels were treated according to Treatment Method B (Table 7). Panels were then electrocoated with EPIC 200 FRAP according to the parameters described above. Panels were scribed and subjected to ASTM G-85 A2 testing as specified in Table 8.

TABLE 22
Scribe Creep results for Example 16.

| First | Second | Cycle B scribe | |
|---|---|---|---|
| Pretreatment | Pretreatment | creep (21 cycles, | Scribe creep per |
| Code | Code | mm) | cycle (mm) |
| PT-1 | None | 1.83 | 0.087 |
| PT-6 | None | 2.14 | 0.102 |
| PT-1 | PT-D | 1.18 | 0.056 |
| PT-6 | PT-D | 3.49 | 0.166 |

The data from Examples 1-12 demonstrate that PT-1 provides a significant degree of corrosion protection. The alkaline cleaner by itself, when run in line with several different formulations of thin film pretreatment solutions, shows relatively poor corrosion resistance. PT-2 and PT-4, which have different compositions and pHs from PT-1, do not show the same degree of corrosion improvement relative to an alkaline cleaner only. PT-3, which contains only a single component of PT-1 (the H₂SiF₆ without the free fluoride component), shows substantially worse corrosion performance relative to PT-1. Further improvements to corrosion performance can be observed with PT-5 on ZEK100, PT-6 on both magnesium alloys, and PT-7 on Eform Plus, all of which contain the free fluoride component of PT-1, with a variant on the fluorometallic acid.

The data from Examples 13-16 demonstrate that, on HDG or aluminum substrates, treatment with a first pretreatment composition followed by a second pretreatment composition improves corrosion performance compared to a substrate treated only with the first pretreatment composition or only the second pretreatment composition.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

We claim:

1. A method of treating a metal substrate comprising:
contacting a surface of the substrate with a first pretreatment composition comprising a fluorometallic acid comprising a Group IVA metal and/or a Group IVB metal and free fluoride in an amount of 10 ppm to 500 ppm based on total weight of the first pretreatment composition and having a pH of 1.0 to 4.0; and
contacting the substrate surface with a second pretreatment composition comprising a Group IVB metal and free fluoride in an amount of 15 ppm to 200 ppm based on total weight of the second pretreatment composition; or
contacting the substrate surface with a third pretreatment composition comprising a lanthanide series metal and an oxidizing agent.

2. The method of claim 1, wherein the first pretreatment composition comprises the Group IVA metal in an amount of 10 ppm to 1,500 ppm and/or the Group IVB metal in an amount of 200 ppm to 5,000 ppm, wherein the amounts are based on total weight of the first pretreatment composition.

3. The method of claim 1, wherein the second pretreatment composition comprises the Group IVB metal in an amount of 20 ppm to 1,000 ppm based on total weight of the second pretreatment composition.

4. The method of claim 1, wherein the second pretreatment has a pH of 2 to 6.5.

5. The method of claim 1, wherein the second pretreatment further comprises an electropositive metal, a Group IA metal, a Group IVB metal, and/or a Group VIIIB metal.

6. The method of claim 5, wherein the second pretreatment comprises:
the electropositive metal in an amount of 2 ppm to 100 ppm;
the Group IA metal in an amount of 2 ppm to 500 ppm;
the Group IVB metal in an amount of 5 ppm to 500 ppm; and/or
the Group VIIIB metal in an amount of 0.1 ppm to 50 ppm,
wherein the amounts are based on total weight of the second pretreatment composition.

7. The method of claim 1, wherein the third pretreatment composition comprises the lanthanide series metal in an amount of 5 ppm to 25,000 ppm based on total weight of the third pretreatment composition.

8. The method of claim 1, wherein the third pretreatment composition comprises the oxidizing agent in an amount of 25 ppm to 13,000 ppm based on total weight of the third pretreatment composition.

9. The method of claim 1, wherein the third pretreatment has a pH of 2 to 5.5.

10. The method of claim 1, wherein the third pretreatment composition is substantially free of gelatin, lanthanide oxide, and/or copper.

11. The method of claim 1, wherein the first pretreatment composition, the second pretreatment composition, and/or the third pretreatment composition is substantially free of chromium and/or phosphate.

12. The method of claim 1, further comprising contacting the substrate surface with a cleaner composition prior to the contacting with the first pretreatment composition and/or contacting the substrate surface with a film-forming composition.

13. The method of claim 12, wherein the film-forming composition comprises an anionic electrodepositable coating composition, a cationic electrodepositable coating composition, a powder coating composition, a liquid coating composition, a primer composition, and/or a topcoat composition.

14. The method of claim 1, wherein the substrate comprises magnesium or a magnesium alloy.

15. A substrate comprising a surface treated with the method of claim 1.

16. The substrate of claim 15, wherein the substrate comprises magnesium or a magnesium alloy.

17. The substrate of claim 15, comprising a layer on the substrate surface formed from one of the first, second, or third pretreatment compositions.

18. The substrate of claim 15, wherein the substrate comprises a vehicle, a part, an article, a heat exchanger, an appliance, a personal electronic device, and/or a multi-metal article.

19. The substrate of claim 18, wherein the vehicle comprises an automobile or an aircraft.
